(19) United States
(12) Patent Application Publication
(10) Pub. No.: US 2009/0319314 A1
(43) Pub. Date: Dec. 24, 2009

(54) METHODS OF COLLECTING AND VISUALIZING GROUP INFORMATION

(75) Inventors: Bradley Lawrence Good, La Canada, CA (US); Markus Hagen, Glendale, CA (US)

Correspondence Address: PERKINS COIE LLP, P.O. BOX 1208, SEATTLE, WA, 98111-1208, US

(73) Assignee: OurGroup, Inc., Pasadena, CA (US)

(21) Appl. No.: 12/479,562

(22) Filed: Jun. 5, 2009

Related U.S. Application Data
(63) Continuation-in-part of application No. 12/144,520, filed on Jun. 23, 2008.

(51) Int. Cl. G06Q 50/00; G06Q 40/00; G06F 15/16; G06Q 20/00; G06Q 10/00; G06F 3/01; G06F 17/30

(52) U.S. Cl. 705/7; 705/39; 709/206; 715/733; 707/100; 715/752

(57) ABSTRACT

A system and methods allow groups to be managed. Various methods of collecting and visualizing group information are described. A group head and various members of organizations can organize fundraising activities or groups based on a common purpose. Group performance can be rated and displayed. Various group successes can be reported.

### RELATED APPLICATIONS

This Application is a continuation-in-part of U.S. Non-Provisional patent application Ser. No. 12/144,520, filed Jun. 23, 2008, and entitled “METHODS OF COLLECTING AND VISUALIZING GROUP INFORMATION” by Bradley Good and Markus Hagen, which is incorporated herein by reference.

### BACKGROUND

Often groups pursue grants to provide capital necessary for furthering the group interest. Individuals can donate directly to groups. Individuals can also donate to foundations and charities. Such foundations and charities can directly provide the funds to groups that can use the funds. At times allocation review committees control such allocations.

Applying for grants can be difficult and impersonal. Group heads are often unable to manage numerous individuals and such fundraising efforts can be disorganized. Allocation review committees need to have clear visibility into the direction that their funds are moving. Individuals often want to know that their donations “count.” Often the efforts of groups, charities, foundations, and individuals can be strained by the process of fundraising. Groups fail to receive grants that could have otherwise been used. Some individuals or foundations may not reach the groups that can use the funds because of the burdens of managing grant applications.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Groups can be managed through a system providing a private interface to the group members and a public interface to individuals outside the group. Group members can provide information to a group record storage that can be managed by group members and a group head. A group knowledge management engine can govern the receipt, storage and retrieval of group information. A group knowledge search module can supply group information to group members and others having permission to view the information. Statistics of group successes in, e.g., fundraising can be calculated and provided to the group by the private interface as well as published to the public interface.

Various methods can be implemented to further the interests of the group. For example, methods can be implemented to collect information from group members, visualize relationships between groups, create a public or private group interface, visualize performance of a group, manage a group, highlight performance of a group, and otherwise organize group members.

### BRIEF DESCRIPTION OF THE DRAWINGS

FIG. 1 depicts an example of a system for managing group members.

FIG. 2 depicts an example of components of a group management engine.

FIG. 3 depicts a flowchart of an example of a method for collecting information from group members.

FIG. 4 depicts a flowchart of an example of a method for visualizing relationships between groups.

FIG. 5 depicts a flowchart of an example of a method for creating a group interface.

FIG. 6 depicts a flowchart of an example of a method for visualizing performance of a group.

FIG. 7 depicts a flowchart of an example of a method for managing a group of individuals.

FIG. 8 depicts a flowchart of an example of a method for highlighting performance of multiple groups.

FIG. 9 depicts an example of a computing system that is representative of the computing systems described herein.

FIG. 10 depicts a flowchart of an example of a method for organizing group members.

FIG. 11 depicts a screenshot of an example of a group registration page.

FIG. 12 depicts a screenshot of an example of a group profile page.

FIGS. 13A-B depicts screenshots of group member import pages.

FIG. 14 depicts a screenshot of a page offering group visualization.

FIG. 15 depicts a screenshot of a page for inviting group member profile activation.

FIGS. 16A-B depict screenshots of an individual within a group and the individual and his profile information after drilling down on the individual.

FIG. 17 depicts a screenshot of visualization of two groups associated by a group member of two groups.

FIGS. 18A-B depict screenshots of groups of groups related by a common member.

FIG. 19 depicts a common factor linking groups within a group.

FIG. 20 depicts a website of a group as created using templates and group information.

FIG. 21 depicts a screenshot of a page displaying group performance based on a variety of criteria.

FIGS. 22A-B depict screenshot of group performance relative to planning.

FIGS. 23A-B depict screenshots of exemplary pages of group fundraising performance over time, source location and amount of donation.

FIG. 24 depicts a template of a page that could be used to create a page with group information.

FIG. 25 depicts an example of a flowchart of a method for requesting funding using a public interface and a private interface.

FIG. 26 depicts a screenshot of an example of a knowledge management center displaying an implementation of widgets.

FIG. 27 depicts a screenshot of a knowledge management center displaying documents created by group members.

FIG. 28 depicts a screenshot of a flow diagram depicting a fundraising and fund allocation chain.

FIG. 29 depicts a screenshot of an example of an interface that can be used to request funds.

FIG. 30 depicts a screenshot of an example of an interface that can be used to define reasons for fundraising.

FIG. 31 depicts a screenshot of an example of an interface that can be used to provide supporting materials to a request for fundraising.

FIG. 32 depicts an example of a system for storing and retrieving information.

FIG. 33 depicts a flowchart of an example of a method for acquiring data.

FIG. 34 depicts a flowchart of an example of a method for saving a unit of data from a website facilitating social financing and/or investment.

FIG. 35 depicts an example of a grant application management system.

FIG. 36 depicts a flowchart of an example of a method for managing grant applications.

FIG. 37 depicts a flowchart of an example of a method for acquiring a grant application template.

FIG. 38 depicts a flowchart of an example of a method for preparing a grant application.

FIG. 39 depicts a flowchart of an example of a method for managing submission of an approved grant application.

FIG. 40 depicts an example of a dock.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

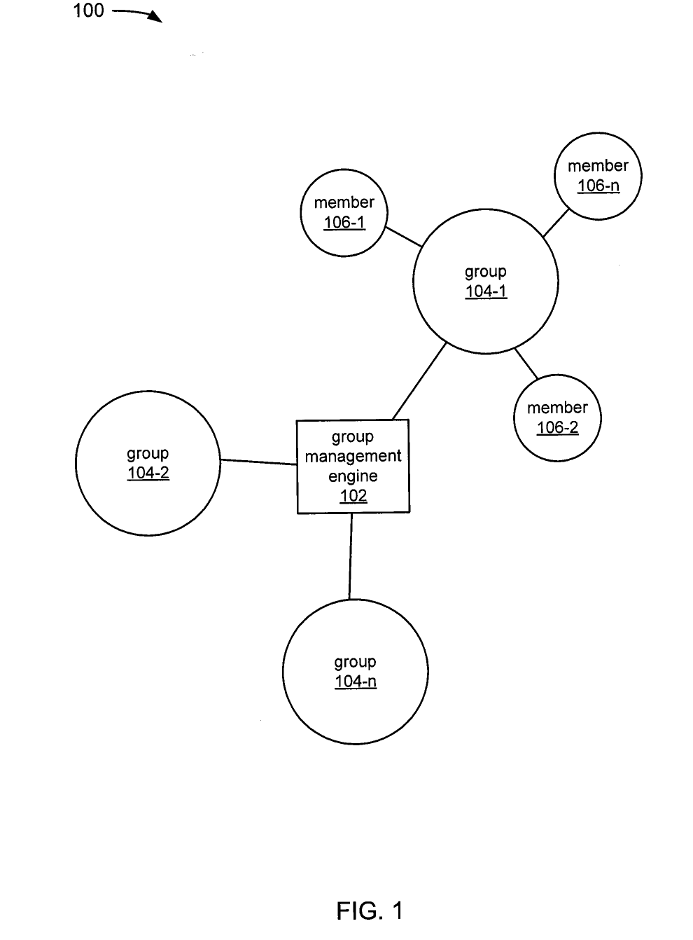

FIG. 1 depicts an example of a system 100 for managing group members. FIG. 1 includes group management engine 102, group 104-1, group 104-2, group 104-n (collectively groups 104), member 106-1, member 106-2, and member 106-n (collectively members 106).

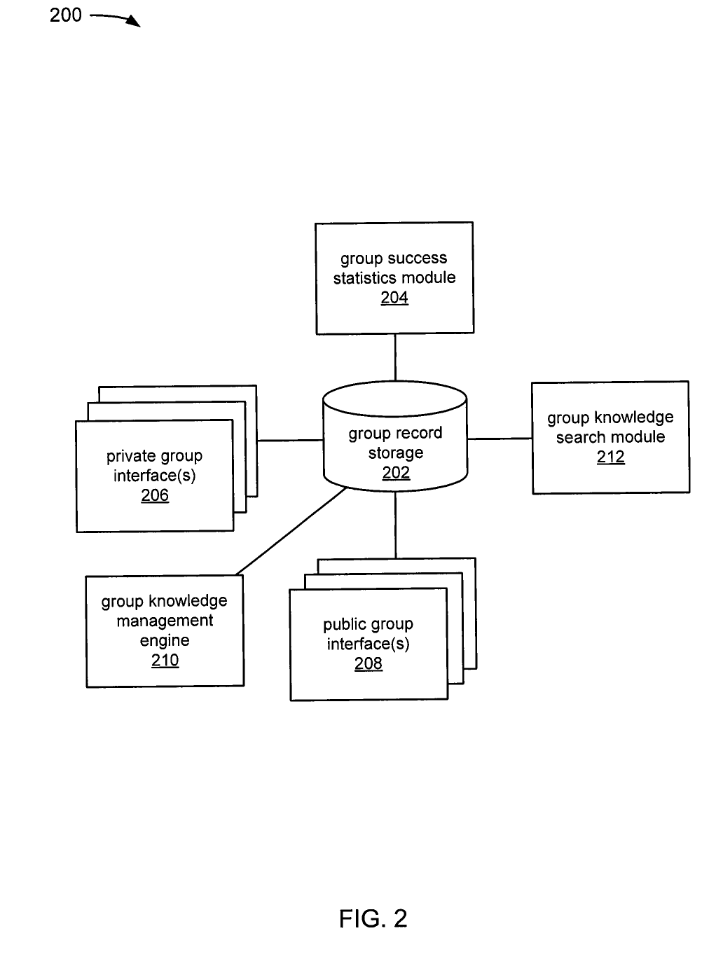

In the example of FIG. 1, group management engine 102 can include any combination of computing devices, such as more than one server class computing device networked together to provide data and information services. The group management engine 102 and modules included therein are discussed in further depth in reference to FIG. 2.

In the example of FIG. 1, the groups 104 include organizations, foundations, religious groups, political groups, corporate entities, and any known or convenient organizations or group of people. The members 106 can be individuals, legal entities, other groups, or any known or convenient entity or organization. While only one group is displayed as having members extending there from, each of groups 104 can have members, but such group members are hidden for clarity.

In the example of FIG. 1, in operation, the members 106 provide information, documents, requests, reports, and any other group related information to the group 104. The group management engine 102 organizes the information and produces various reports for internal and external group use. Statistics of group performance can be generated. Messages to group members can be transmitted and received.

A special type of member or members 106 can be a group head. There can be one or more group heads associated with a group 104. Group heads are typically given permission to manage the associated group including making changes to the group membership via the group management engine 102. In a non-limiting example, at times one of the members 106, acting as a group head, can request information from group members 106 via the group management engine 102. The received information can be stored in the group management engine 102 for group 104-1. Similarly, each group 104 can have one or more group heads administrating or managing the group.

FIG. 2 depicts examples of components 200 of group management engine, such as group management engine 102 as discussed in reference to FIG. 1. FIG. 2 includes group record storage 202, group success statistics module 204, private group interface(s) 206, public group interface(s) 208, group knowledge management engine 210, and group knowledge search module 212.

The group record storage 202 can be any database, data store, file, data structure, or other information management or storage unit. The group record storage 202 includes group information and can store and retrieve information for the group on behalf of group members.

The group success statistics module 204 operates to continuously update existing group performance by retrieving group records from the group record storage 202 and to analyze group performance in view of group planning. For example group performance can be measured as actual group performance relative to planned group performance. In a non-limiting example, group fundraising performance is determined by the group success statistics module 204 in reference to the planned group fundraising.

The private group interface(s) 206 can be a web interface, stand alone graphical user interface (GUI), special purpose computing device, or any other known or convenient device for displaying and receiving information. The private group interface(s) 206 both receive information from group members and provide information to group members. Individuals that are not registered with the group are unable to access the private group interface(s). For example, the private group interface(s) 206 can be protected by an authentication scheme, such as a user identifier/password system. Typically a group head controls the private group interface(s). In a non-limiting example, the private group interface 206 can include or be expressed as a website. The private group interfaces 206 can be used to receive search requests from individual group members.

The public group interface(s) 208 can be, as above, any known or convenient device for displaying and receiving information, including the devices discussed in reference to private group interface(s) 206. The public group interface(s) 208 can be accessible to individuals registered with the group and individuals outside of the group. A group can make a public group interface available to all individuals outside the group, or alternatively access can be limited to certain other groups. In this way, criteria can be defined to determine whether or not to allow an individual to view the public group interface. For example, the criteria can be defined by the group head. The public group interfaces 208 can be used to receive search requests for group information. Such information can be specified as public by group members.

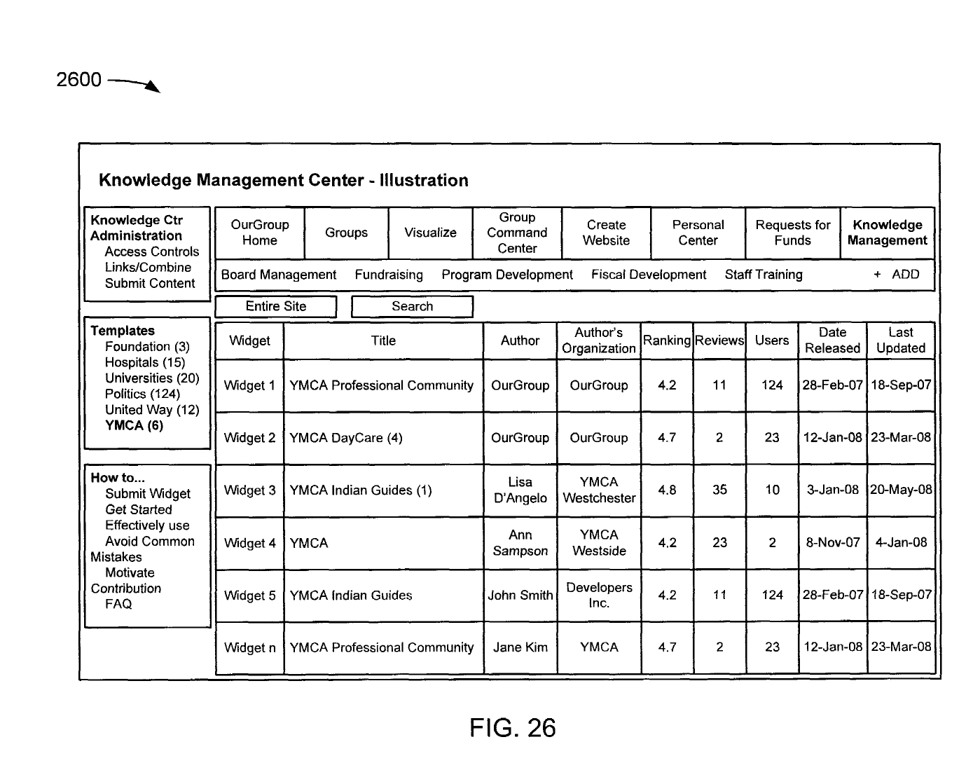

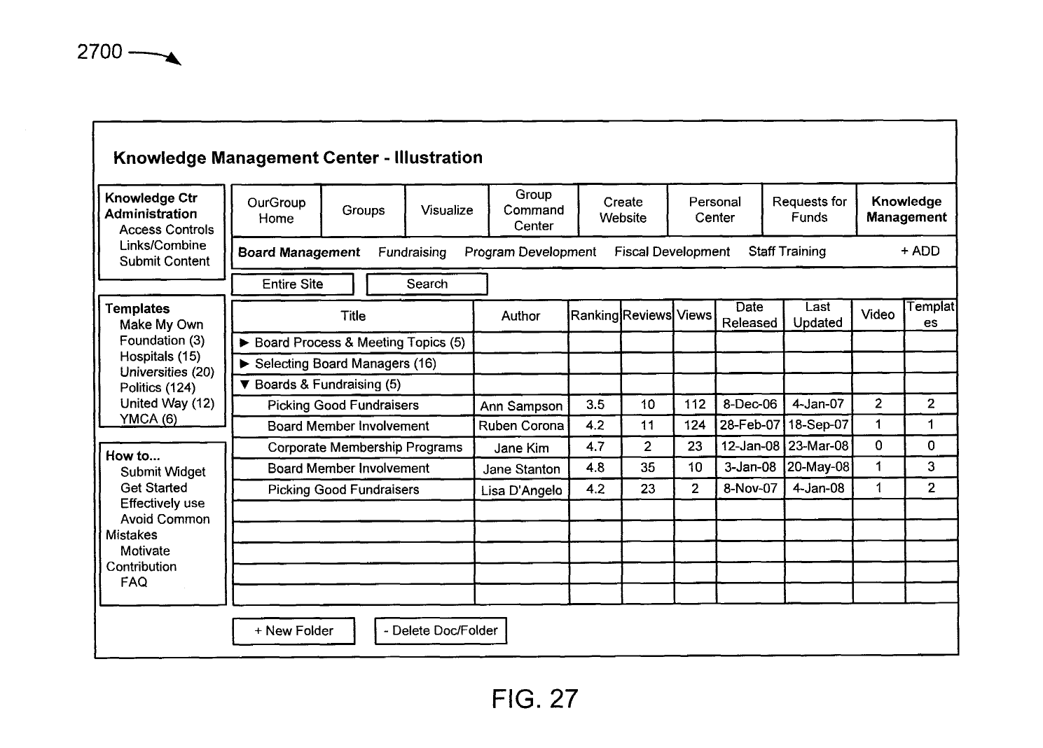

The group knowledge management engine 210 includes a variety of group management functionality, such as widgets, that can link or relate group information stored in the group record storage. Widgets can be knowledge management templates, designed to collect and display particular kinds of information or data. Widgets can be used for any type of information, and can collect and display information. For non-limiting examples of implementations including a knowledge management engine and widgets, please refer to FIG. 26 and FIG. 27. A group head can use the knowledge management engine 210 to collect and send information to and receive information from members. Contact information of the individuals receiving and transmitting the information can be maintained in confidentiality, such as by concealing such contact information from either or both the group head and group members and exposing this information only to the group knowledge management engine 210 for transmission and receipt of communications.

The group knowledge search module 212 can be any search engine, function, and special-purpose computing device, software implementation embodied in a tangible computer readable medium, or other system or device operable to retrieve records including group knowledge. Responsive to a search request, the group knowledge search module 212 retrieves and displays relevant information from the group record storage 202.

In the example of FIG. 2 in operation, the private group interface(s) 206 receive information from group members and store the information in the group record storage 202. The private group interface(s) 206 can also retrieve information from the group record storage 202 and display such information. The group success and statistics module 204 can retrieve the information stored in the group record storage 202, for example, fundraising information, and compute the success of groups relative to their planned fundraising. Such data can be stored in the group record storage 202 and made available to group members by the private group interface(s) 206 and the public group interface(s) 208. Similarly, the public group interface(s) 208 can retrieve group information from the group record storage 202 and display the information to individuals having permission to view the public group interface(s) 208.

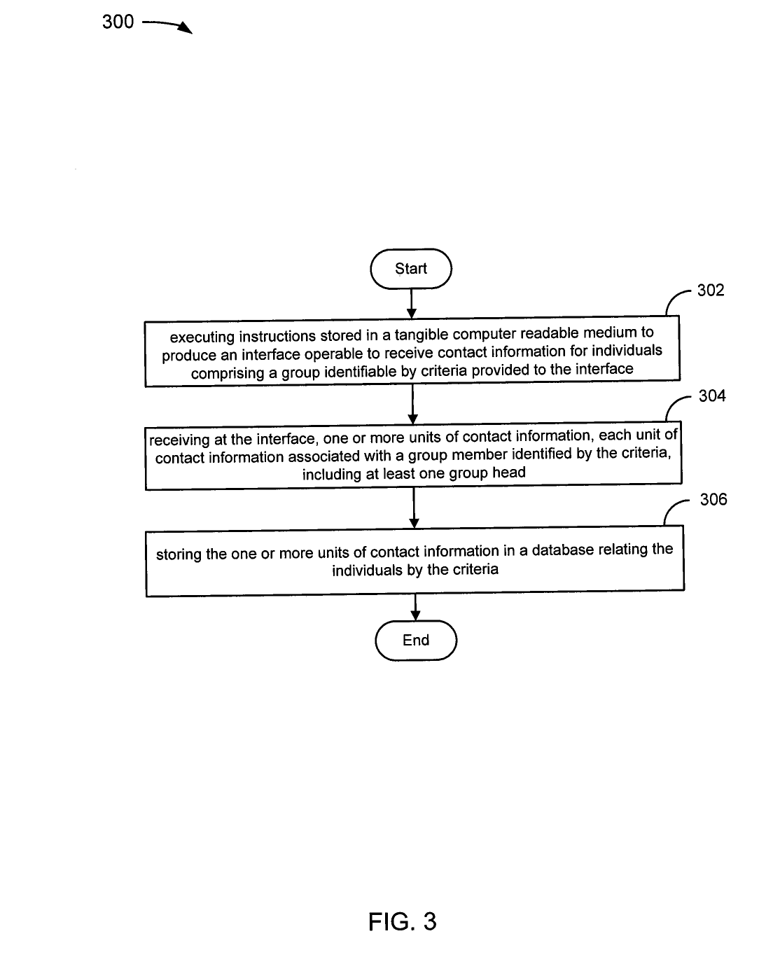

FIG. 3 depicts a flowchart 300 of an example of a method for collecting information from group members. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 3, the flowchart begins at module 302 with executing instructions stored in a tangible computer readable medium to produce an interface operable to receive contact information for individuals comprising a group identifiable by criteria provided to the interface. The interface can be any known or convenient system or device for collecting information from one or more individuals or entities. Typically, the interface is produced by executing the instructions on a computing device and the interface may be displayed on the same computing device, or on another computing device connected thereto by one or more networks. The criteria can include or be based on a common purpose of the group, for example, political, religious, environmental, educational, recreational, or any known or convenient factor commonly identifying the members of the group.

In the example of FIG. 3, the flowchart continues to module 304 with receiving at the interface, one or more units of contact information, each unit of contact information associated with a group member identified by the criteria, including at least one group head. The individual group members may enter their own information, manually or, in a non-limiting example, by v-card. Alternatively, a single member, such as the group head can enter some or all group member information one member at a time or in batches. The authenticity of an individual can be validated, such as by comparing units of contact information with known units of contact information. In another example, widgets can be used to collect information.

For visualization of a group member, colored lights can be used to indicate the status of the group member's profile. For example, authenticity of the individual's contact information can be indicated by displaying, for example, a colored light bulb above an image representing the individual, e.g., green. Similarly, the failed authentication can be indicated by a light of a different color, for example, red. Additionally, a failure to have collected contact information can be indicated, for example by displaying a yellow light. Also, an inactive profile can be indicated by, for example, a grey light. In one example, the individual's contact information can be authenticated by requesting the individual's credit card information.

In the example of FIG. 3, the flowchart continues to module 306 with storing the one or more units of contact information in a database relating the individuals by the criteria. The database can be a common information repository for the group, and may be a section of a database holding information for many groups, wherein each group is associated with a section. Having stored the one or more units of contact information, the flowchart terminates.

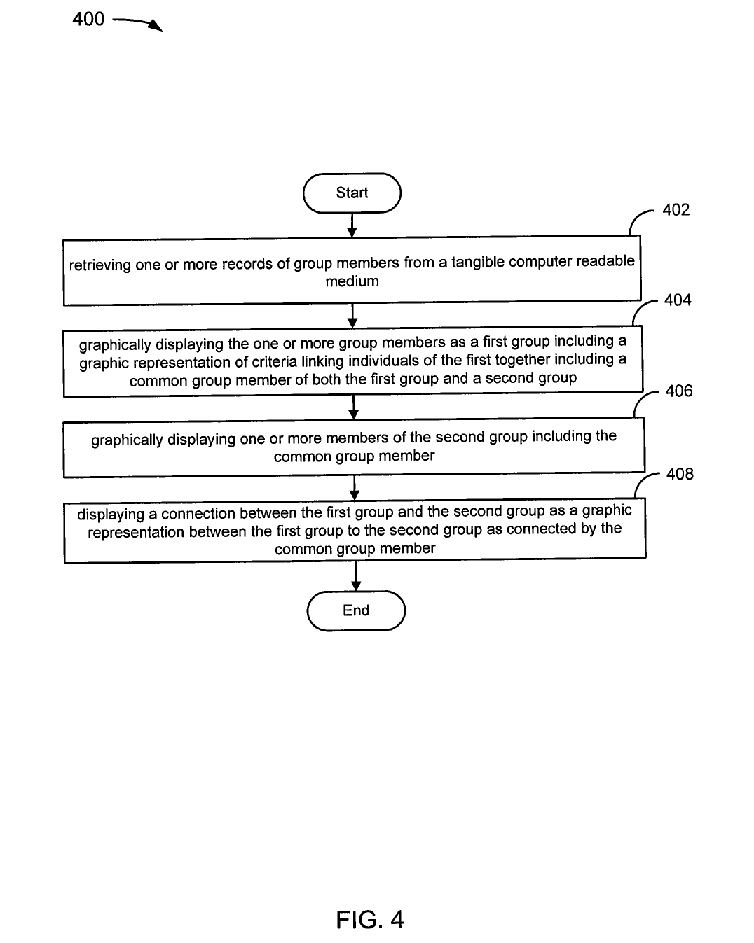

FIG. 4 depicts a flowchart 400 of an example of a method for visualizing relationships between groups. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 4, the flowchart begins at module 402 with retrieving one or more records of group members from a tangible computer readable medium. The records can be records of group members stored in a database including the member's information. The information can include description of the group in terms of sub-groups and members thereof.

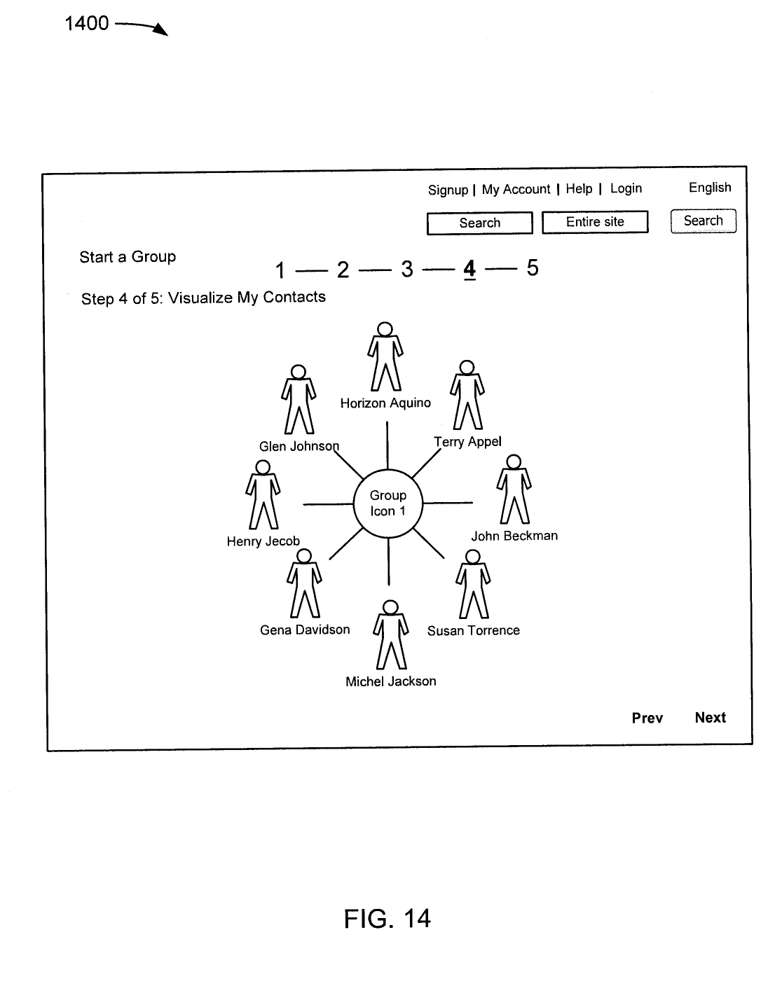

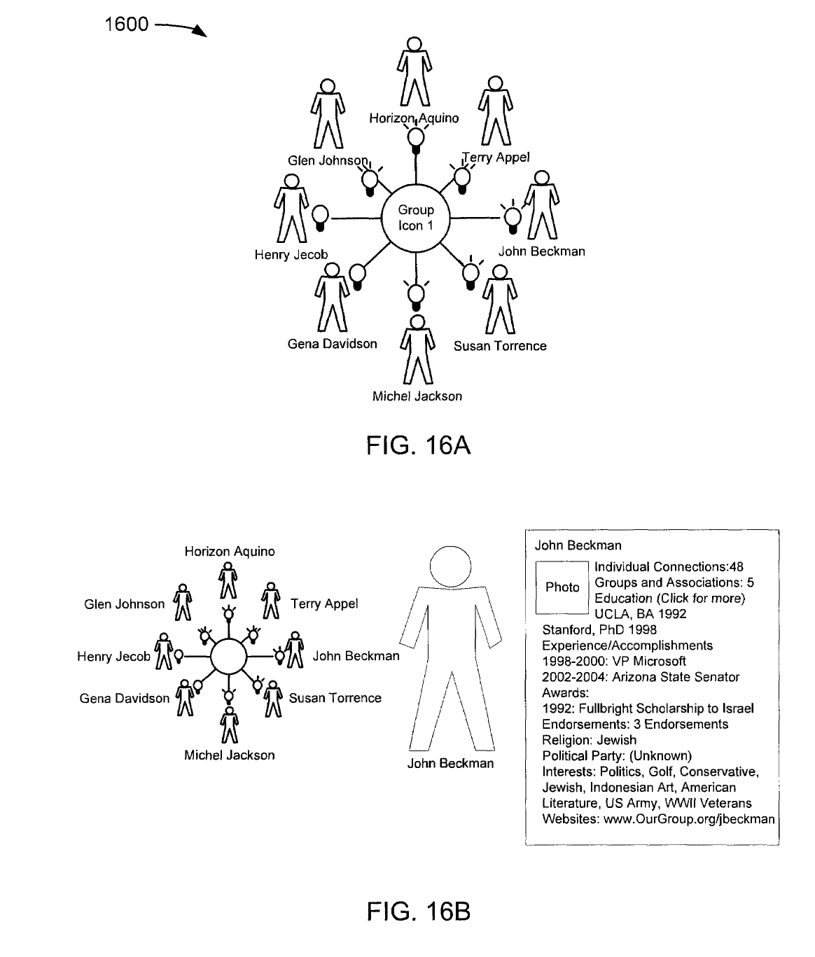

In the example of FIG. 4, the flowchart continues to module 404 with graphically displaying the one or more group members as a first group including a graphic representation of criteria linking individuals of the first group together including a common group member of both the first group and a second group. A non-limiting example of a page created in this regard can be FIG. 14; similarly other non-limiting examples of group visualization can be found in FIGS. 16, 17, 18, and 19. Typically the group members are linked together around a symbol representing a concept or idea the individuals share, such as a charity, cause, or idea.

In the example of FIG. 4, the flowchart continues to module 406 with graphically displaying one or more members of the second group including the common group member. The members of the second group can be displayed in a manner similar to that of the first group.

In the example of FIG. 4, the flowchart continues to module 408 with displaying a connection between the first group and the second group as a graphic representation between the first group and the second group as connected by the common group member. The graphic representation can bring to mind the relationship between the groups visually to allow rapid identification of the common member between the groups. Such a link can be used by the groups to manage relationships between the groups and collaborate on projects as well as further common goals between the groups. Having displayed a connection between the first group and the second group, the flowchart terminates.

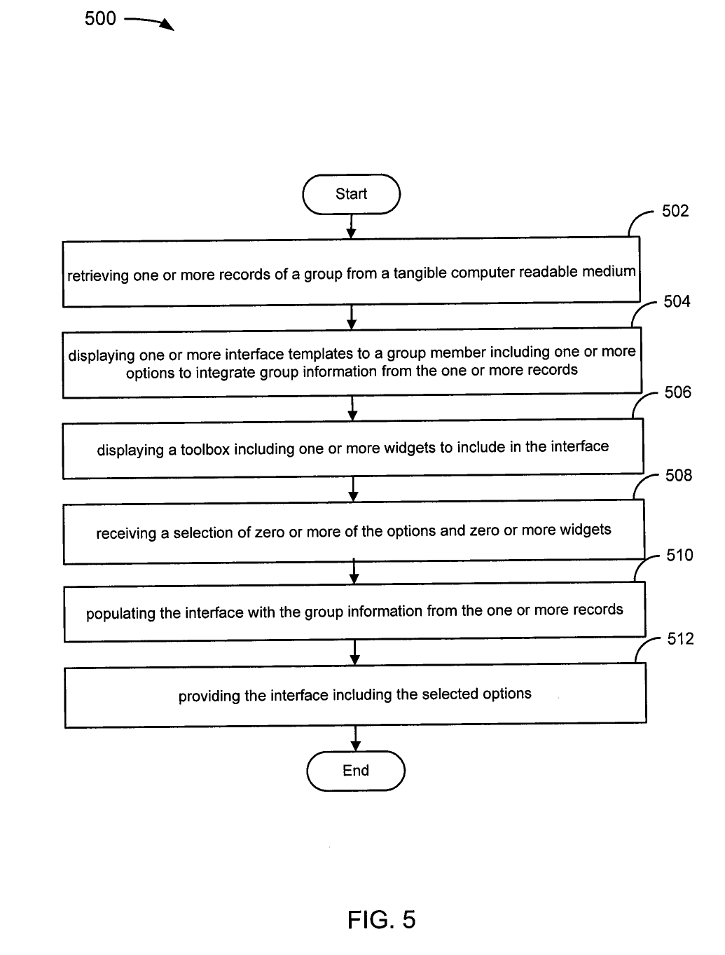

FIG. 5 depicts a flowchart 500 of an example of a method for creating a group interface. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 5, the flowchart begins at module 502 with retrieving one or more records of a group from a tangible computer readable medium. The interface can be public or private. Such records can include information about the group that the group desires to make available. For example, the information can be shared to promote the group's ideals and values to others, or alternatively, the information can be used by the group members for private purposes, such as to manage the group.

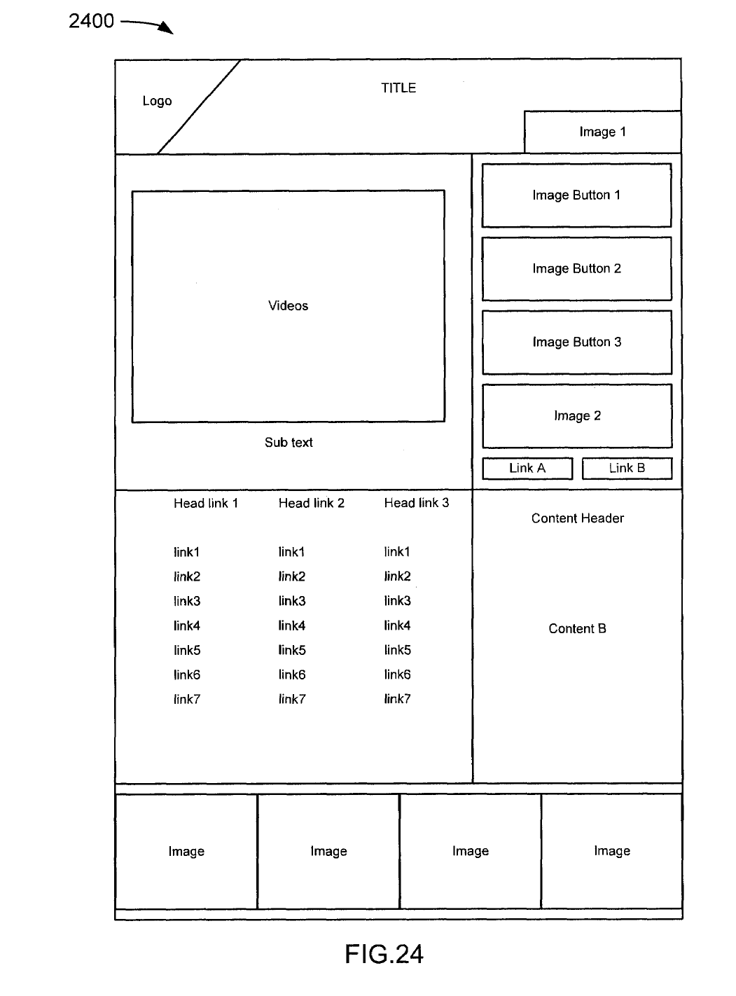

In the example of FIG. 5, the flowchart continues to module 504 with displaying one or more interface templates to a group member including one or more options to integrate group information from the one or more records. The templates can be standardized to include one or more sections in fixed locations, each displaying a specific type of information. A non-limiting example of a template of a page is included in FIG. 24. Options can also be standardized, however, when implemented by the group head or group members, the options can be used in different ways to make radically different interfaces. The group information can be linked to the template, for example, via the options, in order to populate the interface with group information.

In the example of FIG. 5, the flowchart continues to module 506 with displaying a toolbox including one or more widgets to include in the interface. The widgets can be selected by the group head or group member creating the interface to perform basic web application functionality such as to transmit messages to group members via the interface. Such widgets can be highly interactive, and can both automatically populate themselves with information from the group as well as serve as a source of input from group members. For example, a survey widget could be included in the interface to poll group members on a given topic of interest to the group.

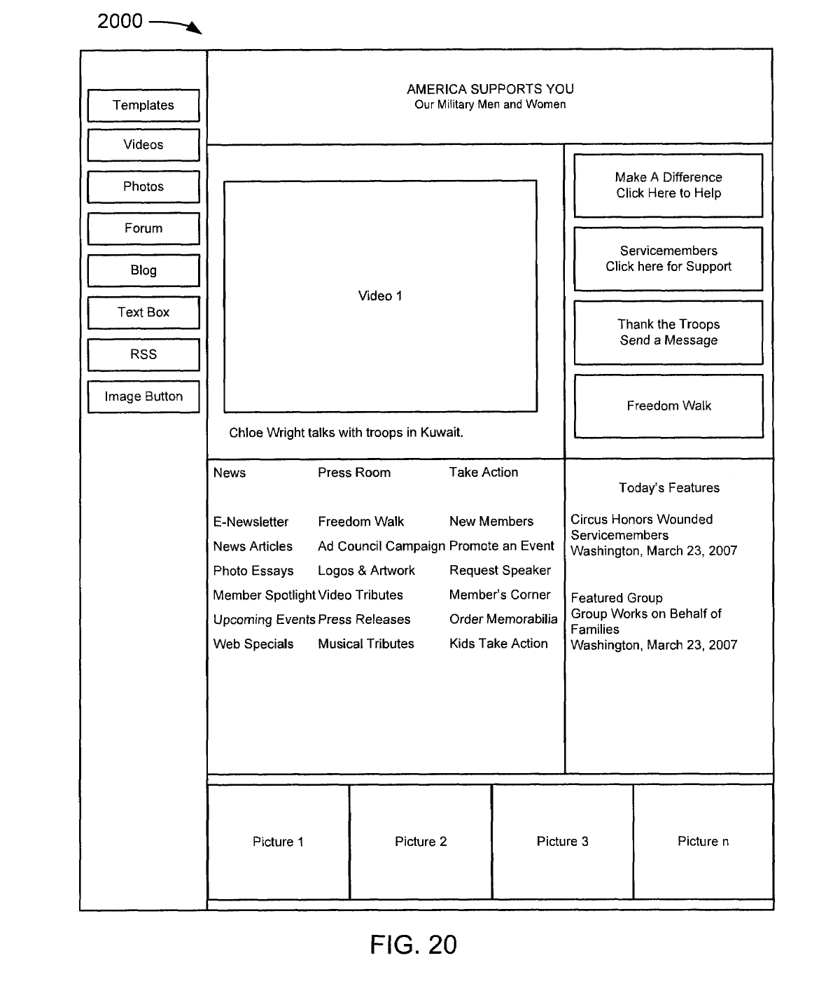

In the example of FIG. 5, the flowchart continues to module 508 with receiving a selection of zero or more of the options and zero or more widgets. The group head or group member places the selected widgets and options throughout the interface and can fill out the interface. A non-limiting example of such an interface is a web page as depicted in FIG. 20.

In the example of FIG. 5, the flowchart continues to module 510 with populating the interface with the group information from the one or more records. The options and widgets can display the group information they are linked to, for example, the names and contact information for group members can be inserted into the interface along with titles, pictures and other group information. The populated interface can appear as though specifically designed for the group. Having populated the interface with the group information, the flowchart terminates.

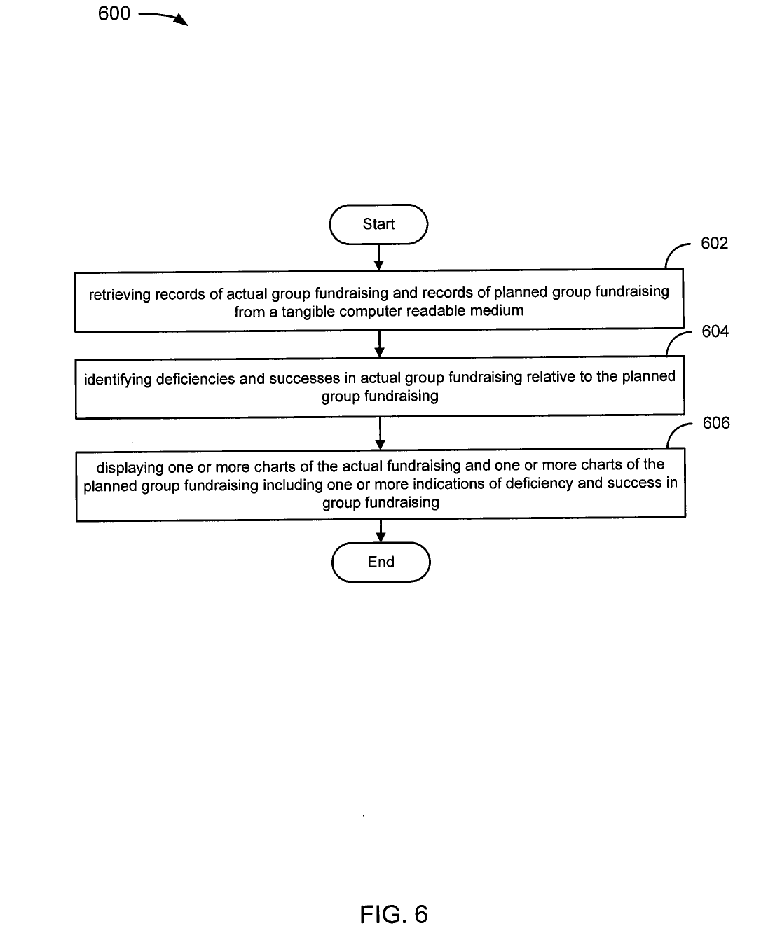

FIG. 6 depicts a flowchart 600 of an example of a method for visualizing performance of a group including, but not limited to, fundraising or recruitment efforts. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

For clarity, the fundraising example will be described. However, any group goal or target can be similarly tracked. In the example of FIG. 6, the flowchart begins at module 602 with retrieving records of actual group fundraising and records of planned group fundraising from a tangible computer readable medium. The planned group fundraising can be an ideal case or estimated, such as goals and sub-goals for a group over time, whereas the actual group fundraising includes the donations received by the group. The relationship of planned to actual can differ substantially, such as where the group has had a particularly good or bad year in fundraising.

In the example of FIG. 6, the flowchart continues to module 604 with identifying deficiencies and successes in actual group fundraising relative to the planned group fundraising. Such deficiencies and successes can be identified by summing donations over a period of time and correlating the sum with a similar sum of the planned group fundraising. Where the planned fundraising is higher than the donations, the donations can be said to be deficient relative to the planned amounts. Similarly, where the planned fundraising is lower than the donations, it can be said that there was success in fundraising.

In the example of FIG. 6, the flowchart continues to module 606 with displaying one or more charts of the actual fundraising and one or more charts of the planned group fundraising including one or more indications of deficiency and success in group fundraising. The donations can be displayed along with the planned fundraising over time to indicate the points and times at which the group was particularly successful or deficient. The group members responsible for the fundraising can be identified, either specifically, or by, e.g., geographic region, demographic, affiliation, or other factor. Having displayed one or more charts of the actual fundraising and one or more charts of the planned group fundraising, the flowchart terminates.

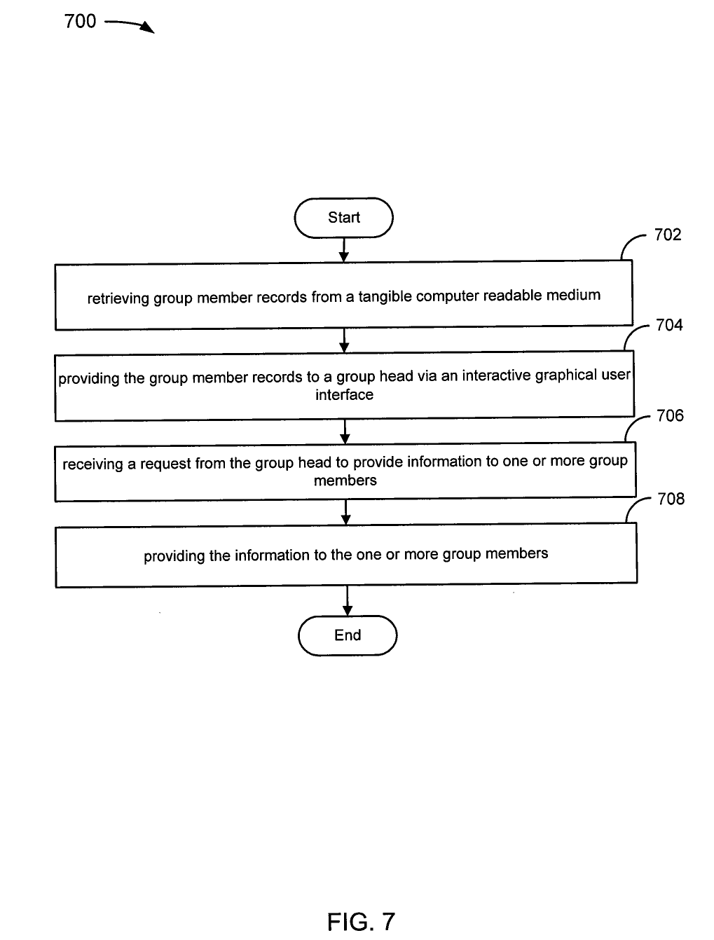

FIG. 7 depicts a flowchart 700 of an example of a method for managing a group of individuals. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 7, the flowchart starts at module 702 with retrieving group member records from a tangible computer readable medium. The group member records can include, for example, contact information and group affiliation as well as any prior history the member has had in the group.

In the example of FIG. 7, the flowchart continues to module 704 with providing the group member records to a group head via an interactive graphical user interface. The information retrieved can be organized, for example, by member name, or other categorizing factor. Options can be provided to, for example, contact the member, remove the member from the group, or perform other management tasks related to the member.

In the example of FIG. 7, the flowchart continues to module 706 with receiving a request from the group head to provide information to one or more group members. The request can be tailored to identify many group members or a single group member to receive the information. The information can include a request for the group members to respond to, for example, a request for donations.

In the example of FIG. 7, the flowchart continues to module 708 with providing the information to the one or more group members. Such information can be delivered to the group members by an interface such as by notification that the individual has received a message and should retrieve the message from the group interface. Having provided the information to the one or more group members, the flowchart terminates.

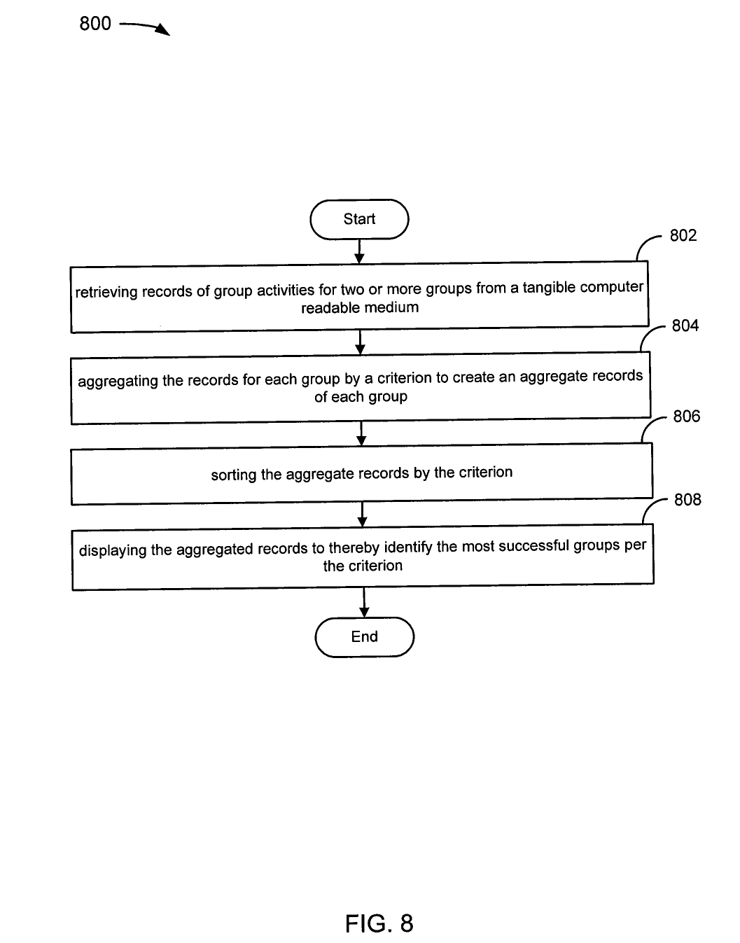

FIG. 8 depicts a flowchart 800 of an example of a method for highlighting performance of multiple groups. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 8, the flowchart starts at module 802 with retrieving records of group activities for two or more groups from a tangible computer readable medium. The two or more groups can be involved in similar activities, for example, fundraising. The groups can be compared on a variety of factors for example, size, ranking, or any other comparable factor that could be used to compare groups. Any portion of a group interface or the group itself can be ranked, such as group blogs, groups overall, fundraising, or any other aspect or feature of a group. Group videos can be specified as the criteria on which to compare groups, such as by comparing rankings or quantities of group videos. Categories of groups can be broken down such as by type of group, for example, health, environment, politics and religion.

In the example of FIG. 8, the flowchart continues to module 804 aggregating the records for each group by a criterion to create aggregate records of each group. Aggregation of the records can be accomplished over time, for example, to determine the highest rated group over the most recent week. Alternatively, the aggregation can be completed continuously, so as to provide a constantly updated value by factor for the groups.

In the example of FIG. 8, the flowchart continues to module 806 sorting the aggregate records by the criterion. Groups can be organized in descending or ascending order, so as to find the highest and lowest rated group by factor.

In the example of FIG. 8, the flowchart continues to module 808 with displaying the aggregated records to thereby identify the most successful groups per the criterion. The display of the highest rated groups can be visual, including a breakdown of the group's performance over time, and over multiple factors such as by geographic location over time. Such breakdowns could be used to compare various sub-groups of a group. Having displaying the aggregated records, the flowchart terminates.

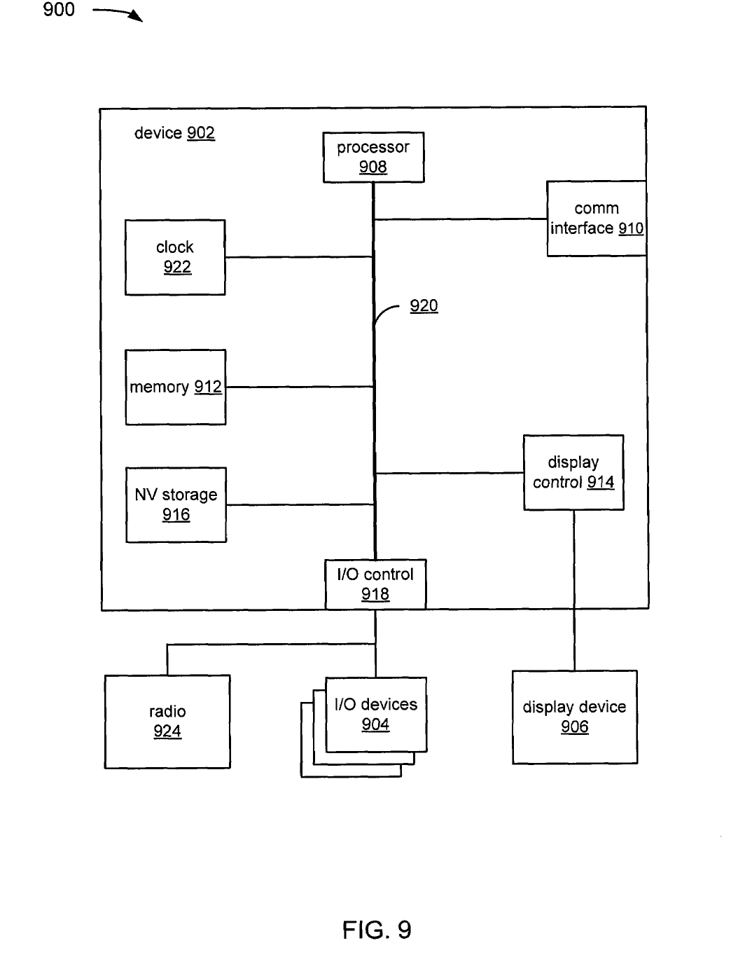

FIG. 9 depicts an example of a computing system that is representative of the computing systems described herein. The system 900 may be a conventional computer system that can be used as a client computer system, such as a wireless client or a workstation, or a server computer system. The system 900 includes a device 902, I/O devices 904, and a display device 906. The device 902 includes a processor 908, a communications interface 910, memory 912, display controller 914, non-volatile storage 916, I/O controller 918, clock 922, and radio 924. The device 902 may be coupled to or include the I/O devices 904 and the display device 906.

The device 902 interfaces to external systems through the communications interface 910, which may include a modem or network interface. It will be appreciated that the communications interface 910 can be considered to be part of the system 900 or a part of the device 902. The communications interface 910 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems over a network.

The processor 908 may be, for example, a conventional microprocessor such as an Intel Pentium microprocessor or Motorola Power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

The I/O devices 904 can include a keyboard, disk drives, printers, a scanner, and other input and output devices, including a mouse or other pointing device. The display controller 914 may control images and text or other displayed items on the display device 906, which can be, for example, a cathode ray tube (CRT) or liquid crystal display (LCD). The display controller 914 and the I/O controller 918 can be implemented with conventional well known technology.

The non-volatile storage 916 is often a magnetic hard disk, flash memory, an optical disk, or another form of storage for large amounts of data. Some of this data is often written, by a direct memory access process, into memory 912 during execution of software in the device 902. One of skill in the art will immediately recognize that the terms “machine-readable medium” or “computer-readable medium” includes any type of storage device that is accessible by the processor 908.

Clock 922 can be any kind of oscillating circuit creating an electrical signal with a precise frequency or other device for tracking time. In a non-limiting example, clock 922 could be a crystal oscillator using the mechanical resonance of vibrating crystal to generate the electrical signal.

The radio 924 can include any combination of electronic components, for example, transistors, resistors and capacitors. The radio is operable to transmit and/or receive signals.

The system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A Web TV system, which is known in the art, is also considered to be a computer system, but it may lack some of the features shown in FIG. 9, such as certain input or output devices. A typical computer system will usually include at least a processor, memory, and a bus coupling the memory to the processor.

In addition, the system 900 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 916 and causes the processor 908 to execute the various acts required by the operating system to input and output data and to store data in memory, including storing files on the non-volatile storage 916.

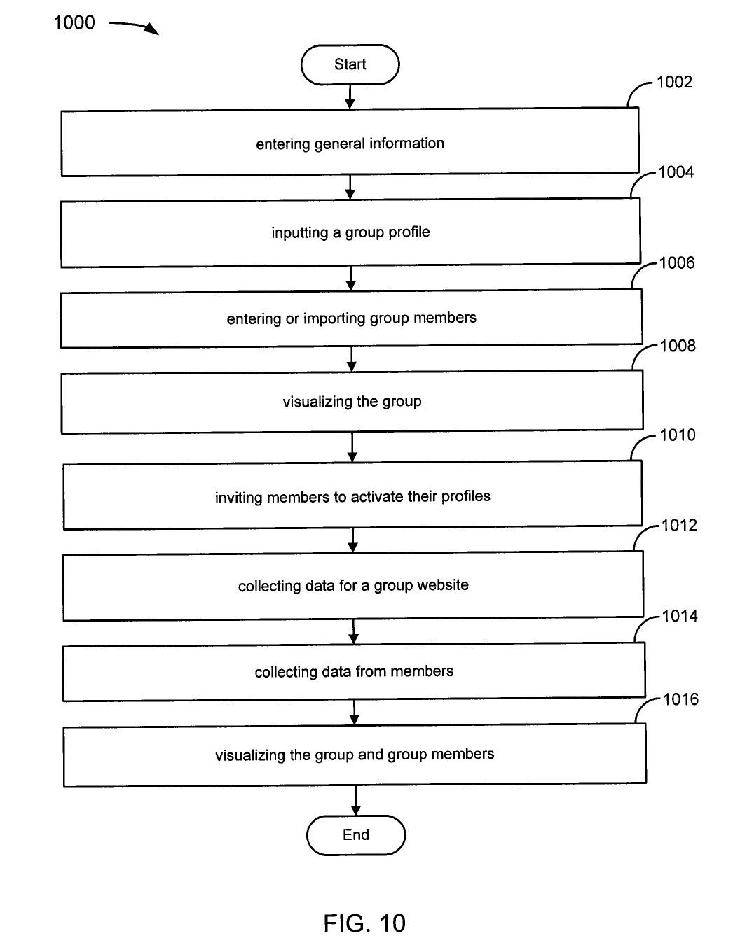

FIG. 10 depicts a flowchart 1000 of an example of a method for collecting group information in starting a group. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

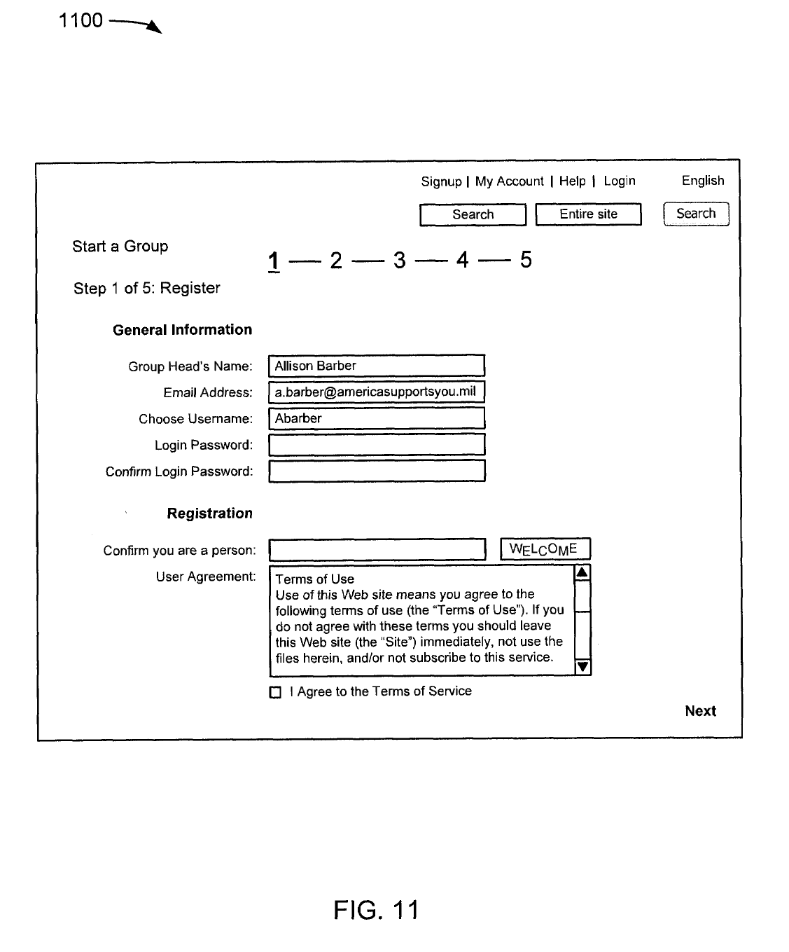

In the example of FIG. 10, the flowchart starts at module 1002 with entering general information. General information may include a group head name, an email address, username, password, a confirmation that the person applying is a person rather than a computer program e.g. type in a word from an image that cannot be machine read, and a user agreement. In a non-limiting example FIG. 11 displays an image of a page that could be used to enter general information.

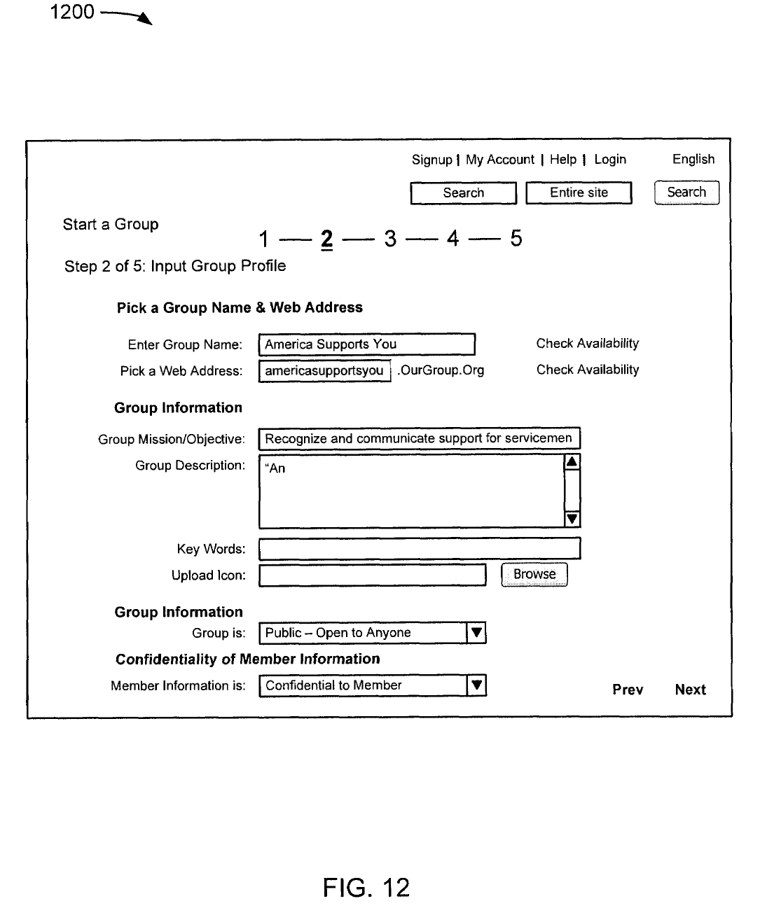

In the example of FIG. 10, the flowchart continues to module 1004 with inputting a group profile, which may include picking a group name, web address, group objective(s), group description, key words, group icon, membership criteria, and confidentiality of member information. For example, the web address can extend as webaddress.ourgroup.org. In a non-limiting example, FIG. 12 displays an image of a page that could be used to input a group profile.

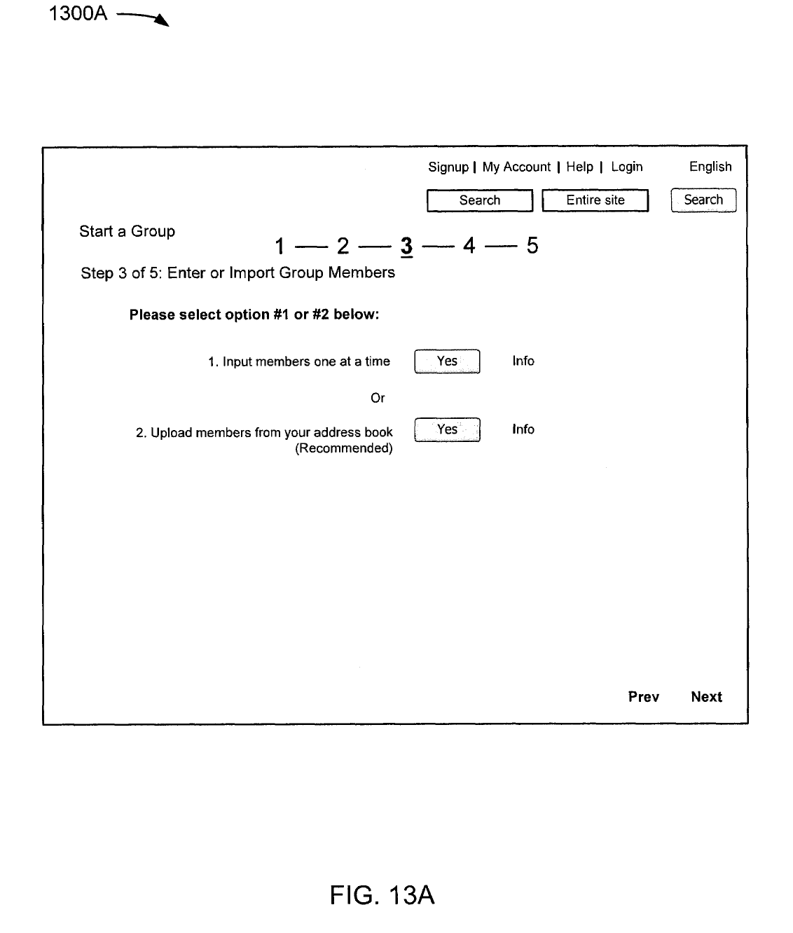

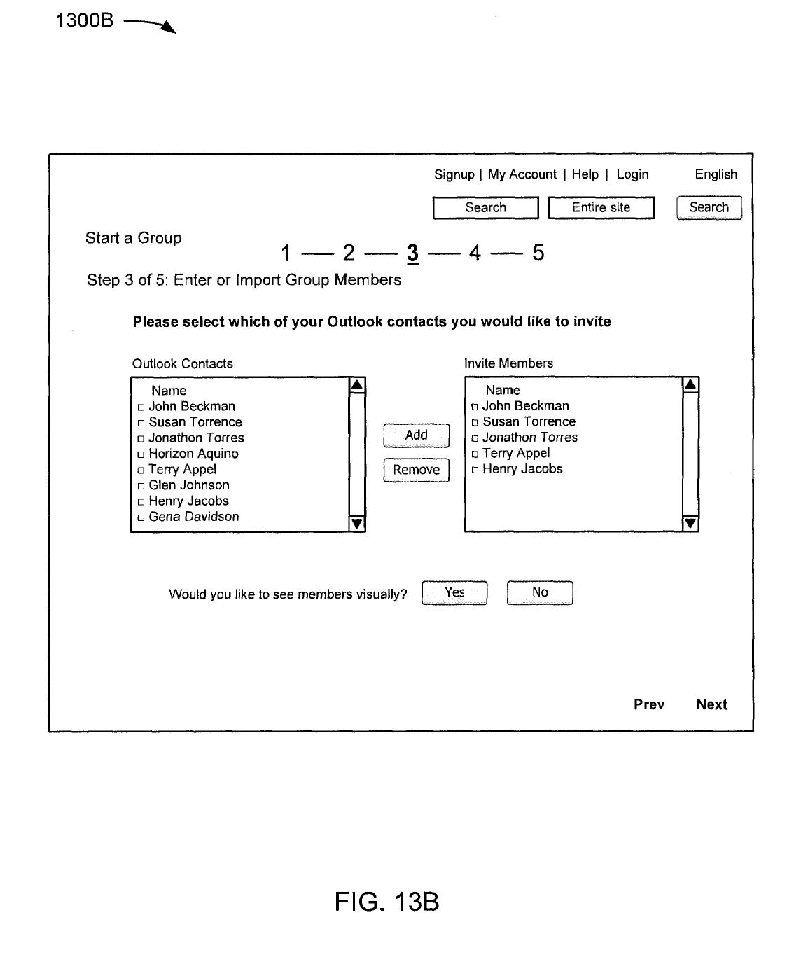

In the example of FIG. 10, the flowchart continues to module 1006 with entering or importing group contact information. The user may type in information or, in a non-limiting example, import contacts from a third-party program such as Microsoft Outlook® using an application programmer interface (API) for importing contacts. FIG. 13A-B display non-limiting examples of pages that could be used to enter or import group contact information. FIG. 13A displays a page that can be used to decide between options such as whether to enter contact information or to import contacts. FIG. 13B displays an image of selecting contacts from Outlook.

In the example of FIG. 10, the flowchart continues to module 1008 with visualizing the group. In a non-limiting example, FIG. 14 displays a group as visualized by centralizing a group icon and locating individual members around the group icon with lines connecting the individual members to the group icon.

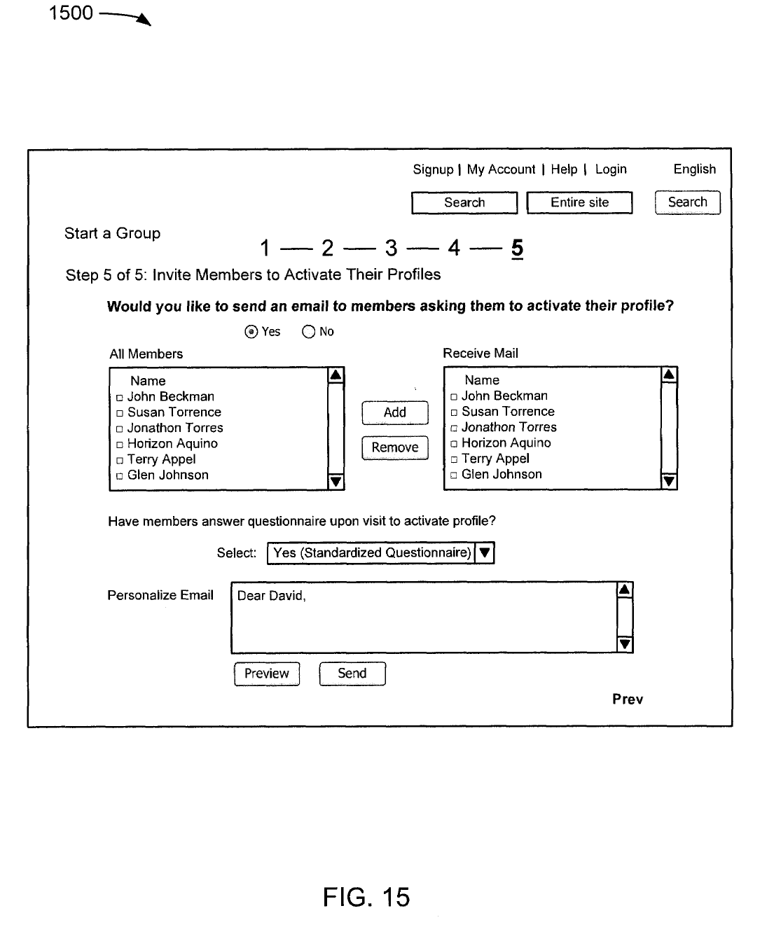

In the example of FIG. 10, the flowchart continues to module 1010 with inviting members to activate their profiles. In an illustrative embodiment, the group members are emailed invitations, such as by creating a message and delivering it to each member's email account. In a non-limiting example, FIG. 15 displays an image of a page for inviting members to activate their profiles.

In the example of FIG. 10, the flowchart continues to module 1012 with collecting data for a website. In an illustrative embodiment a user drags and drops data using an AJAX style website. Examples of data to drag and drop are photos, blogs, text boxes, RSS feed, and video clips. In a non-limiting example, FIG. 20 displays a page which can receive drag and drop data.

In the example of FIG. 10, the flowchart continues to module 1014 with collecting data from members. This data includes specific individual information describing the member e.g. education, employment, religion, political affiliation, contact information, interests, personal website etc.

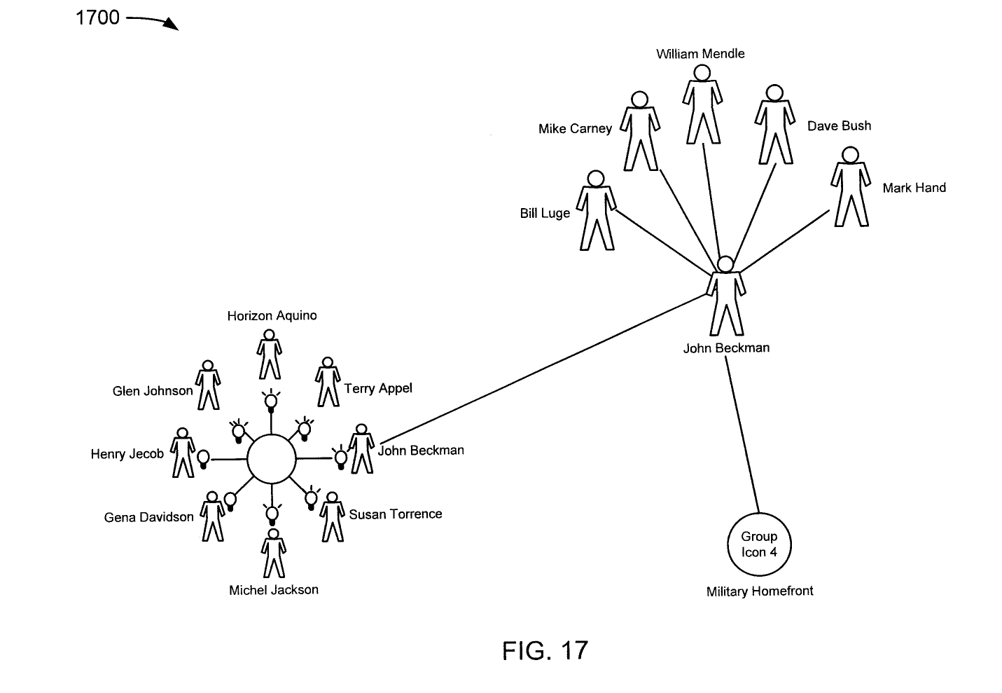

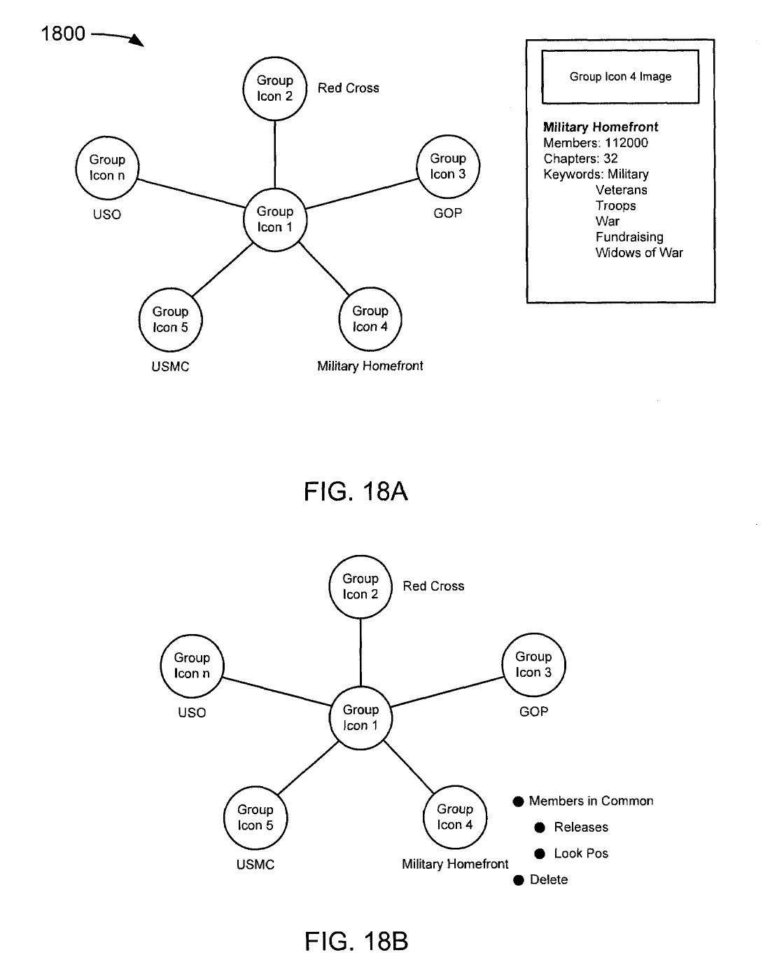

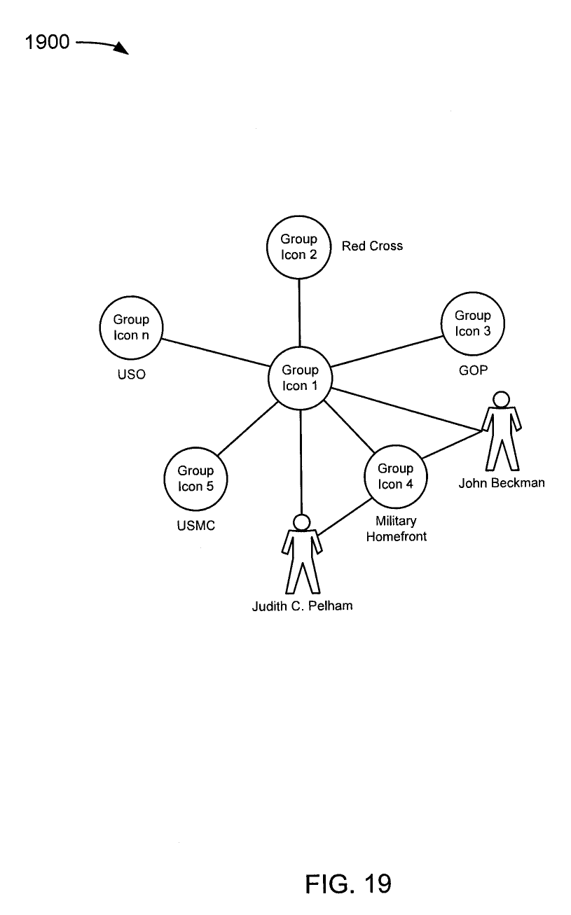

In the example of FIG. 10, the flowchart continues to module 1016 with visualizing the group. Although there are numerous ways to display the present data, the following specific non-limiting examples are provided for clarity. In a non-limiting example, FIG. 16A-B display pages of a group. Yellow lights indicate individuals that have joined the system and activated profiles. Un-lit lights indicate individuals that have not joined the system and activated their profiles. In FIG. 16A, a user may drill down (interact with a page, such as by clicking) on an individual in the group to identify profile information about the individual. FIG. 16B displays an individual and his profile information after drilling down on the individual. Further, FIG. 17 displays an example of a page depicting visualization of group associations as linked by the individual discussed in reference to FIG. 16B. The Individual is a link between two groups, and the visualization displays both groups and the links to identify groups and their relationships. FIG. 18A-B and FIG. 19 depict groups and their relationships.

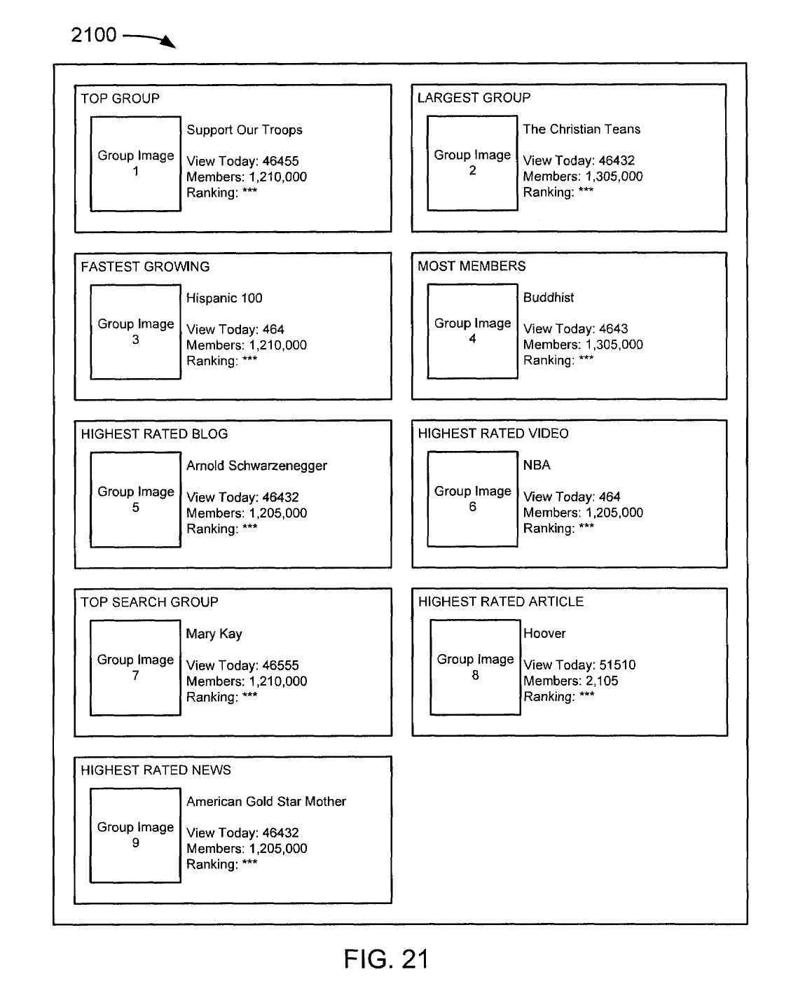

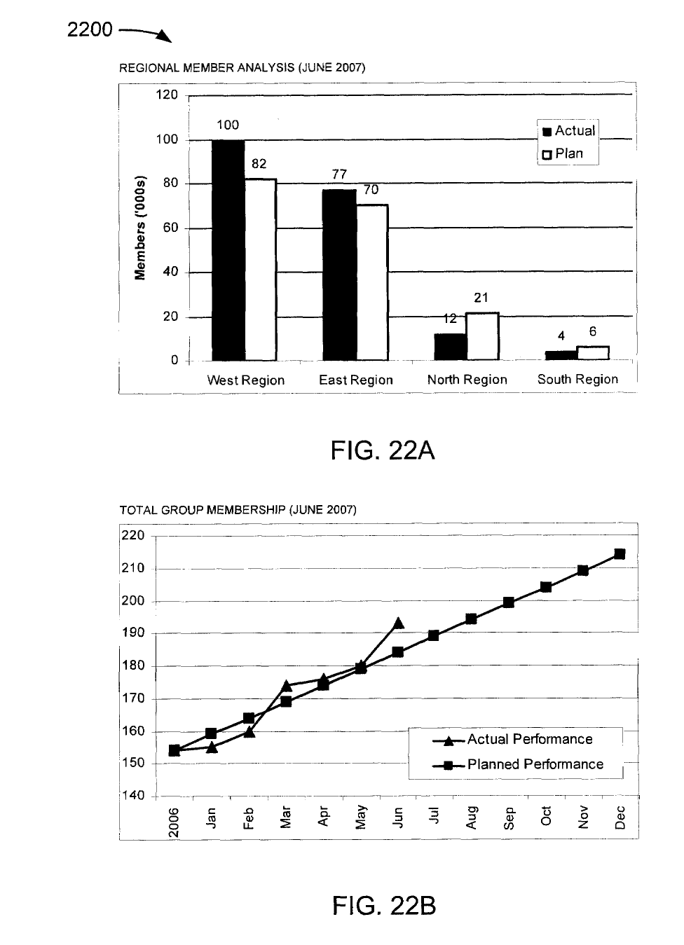

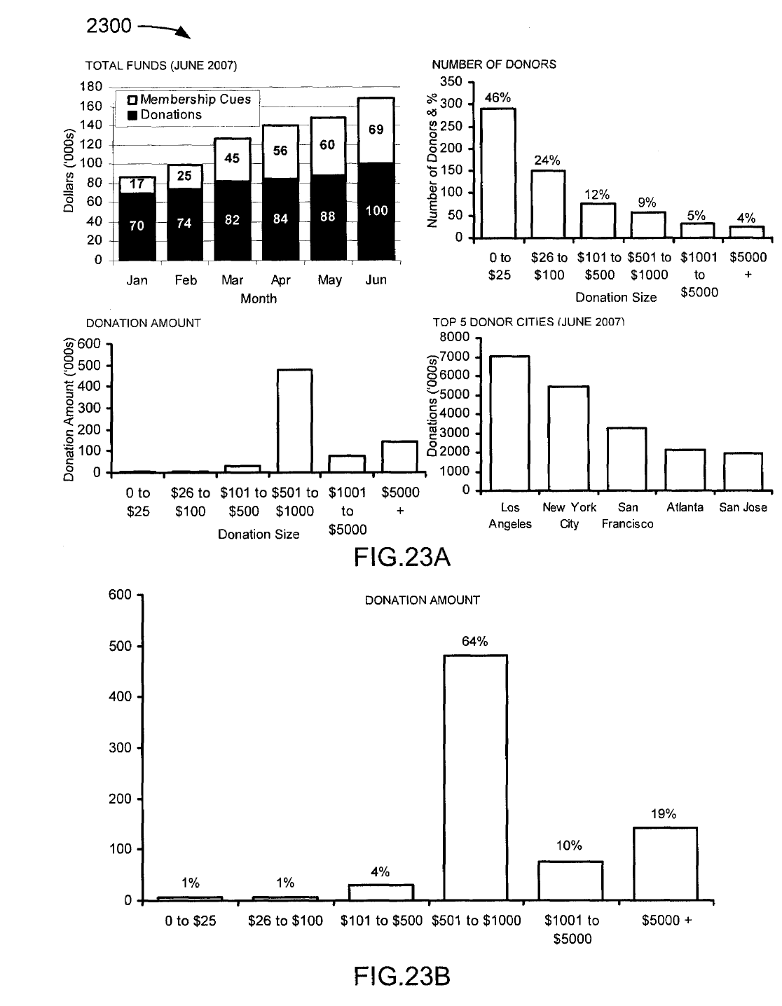

Further specific profile information about the groups can be displayed, as is shown in non-limiting example FIG. 19. Further, a variety of specific group metrics, statistics, and other information can be displayed, for example, the top group, largest group, fastest growing, most members, highest rated blog, highest rated video, top search group, highest rated article, and highest rated news can be determined. FIG. 21 displays a non-limiting example of a page providing metrics, statistics and other information. Group members can request detailed charting and graphing of this information as well. FIG. 22A-B, display examples of pages showing growth in membership of a group. FIG. 23A-B display pages of funding information which can be used to track donations to the group. The pages include detail of the group's donation amounts and specific statistics, for example, geographic descriptions such as top 5 cities, a histogram of donation amount, number of donors and total funds. Having visualized the group and group members, the flowchart terminates.

FIG. 24 depicts a template of a page to be used to create a page with group information. The group information page includes one or more interface templates including one or more options to integrate group information from one or more records. The templates can be standardized to include one or more fixed locations, each displaying a specific type of information. Options can also be standardized. However, when implemented by the group head or group members, the options can be used in different ways to make radically different interfaces. Group information can be linked to the template, for example, via the options, in order to populate the interface with group information.

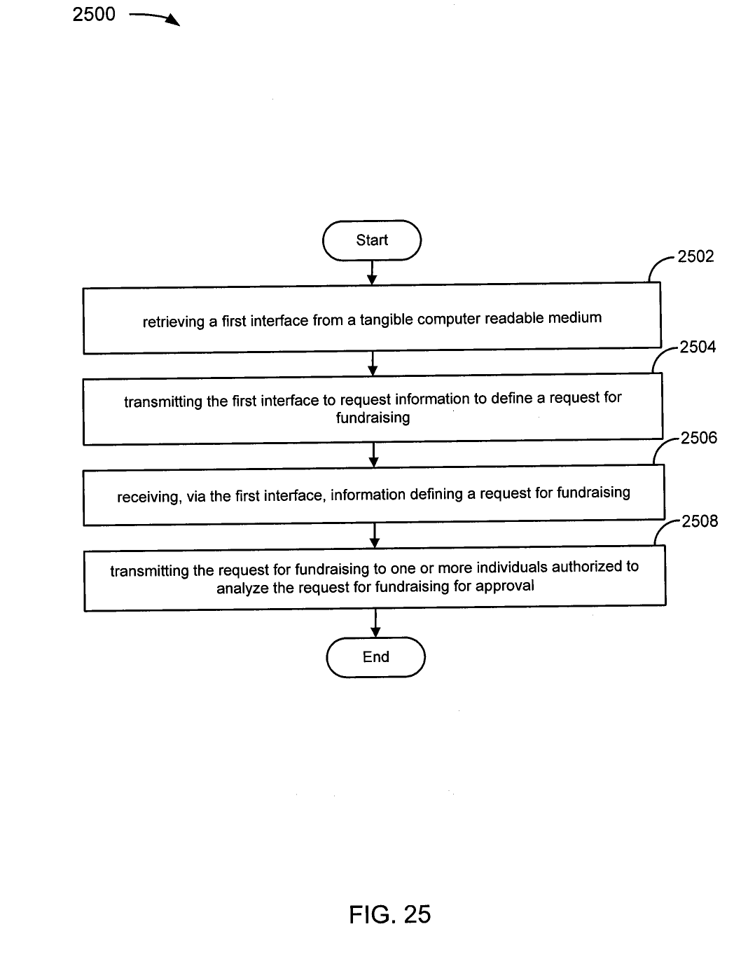

FIG. 25 depicts an example of a flowchart 2500 of a method for requesting funding using a public interface and a private interface. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 25, the flowchart starts at module 2502 with retrieving a first interface from a tangible computer readable medium. The interface can be designed to collect information from a group member or members seeking fundraising for group activities. Such an interface can define the information to be collected on behalf of individuals or committees that will approve or provide the funding. The interface defines a standard funds request application allowing easy review by fund allocation entities.

In the example of FIG. 25, the flowchart continues to module 2504 with transmitting the first interface to request information to define a request for fundraising. The interface can be electronically transmitted. In a non-limiting example, the hypertext transfer protocol can be used to transmit the interface as a web page.

In the example of FIG. 25, the flowchart continues to module 2506 with receiving, via the first interface, information defining a request for fundraising. The information can be tailored to the interface and can include requests for video, documentation, an executive summary, a financial plan, a presentation and any additional information known or convenient for the fundraising process.

In the example of FIG. 25, the flowchart continues to module 2508 with transmitting the request for fundraising to one or more individuals authorized to analyze the request for fundraising for approval. Such transmission can include videos and documentation defining the request for fundraising and summarizing key reasons for the fundraising request. Such individuals can be members of the group, members of other groups, members of charities, foundations, wealthy individuals, or any known or convenient individuals involved in the funding process. Such individuals can then transmit an approval for the request as well as the funds. The group members can then receive the approval and funding. Having transmitted the request for fundraising, the flowchart terminates.

FIGS. 26 to 31 include screenshots of various examples of collecting and visualizing group information. The screenshots are intended to be exemplary only and are not intended to be limiting. FIG. 26 depicts a screenshot 2600 of an example of a knowledge management center displaying an implementation of widgets. Various administrative functions are displayed and group widgets are displayed including group affiliation and author information. FIG. 27 depicts a screenshot 2700 of a knowledge management center displaying documents created by group members. In the example, the documents describe boards and fundraising information useful in, for example, picking good fundraisers.

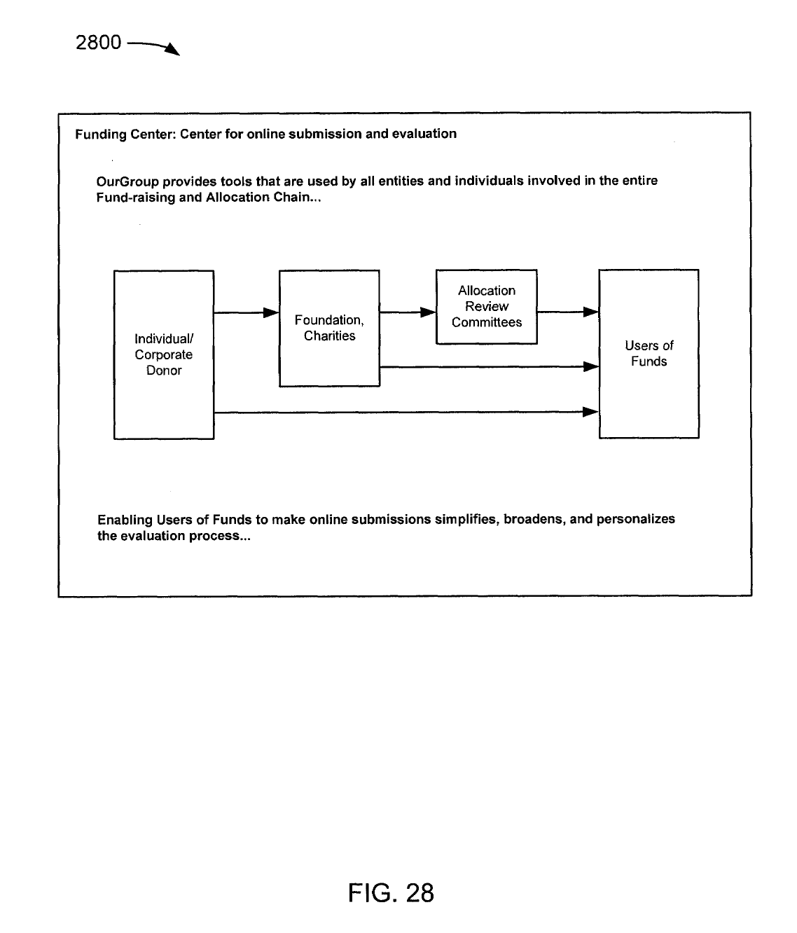

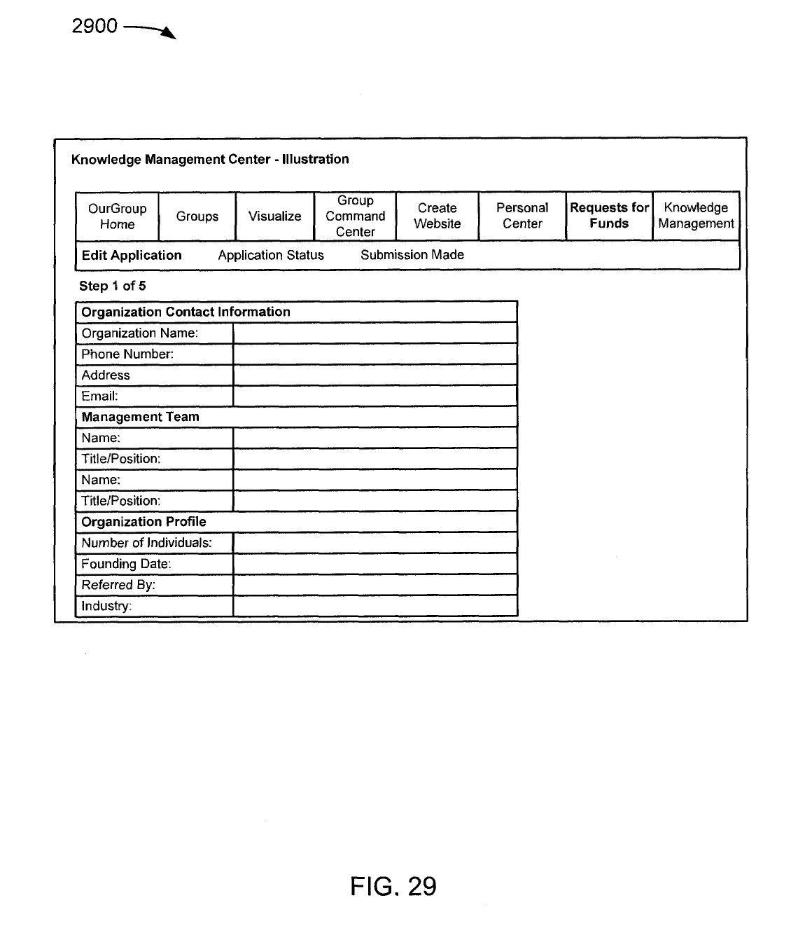

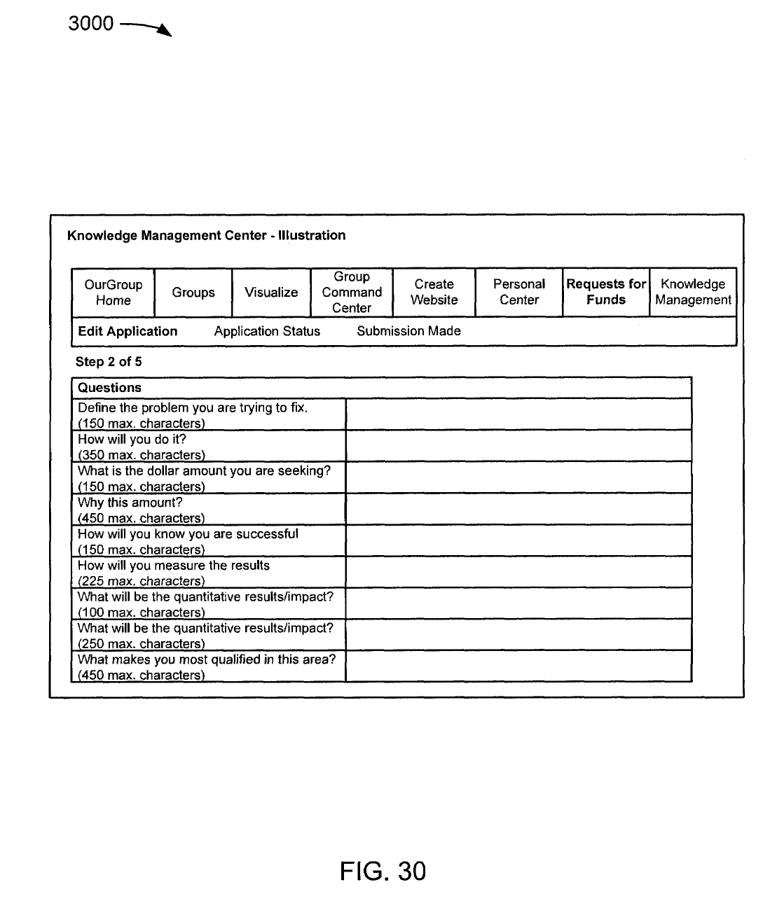

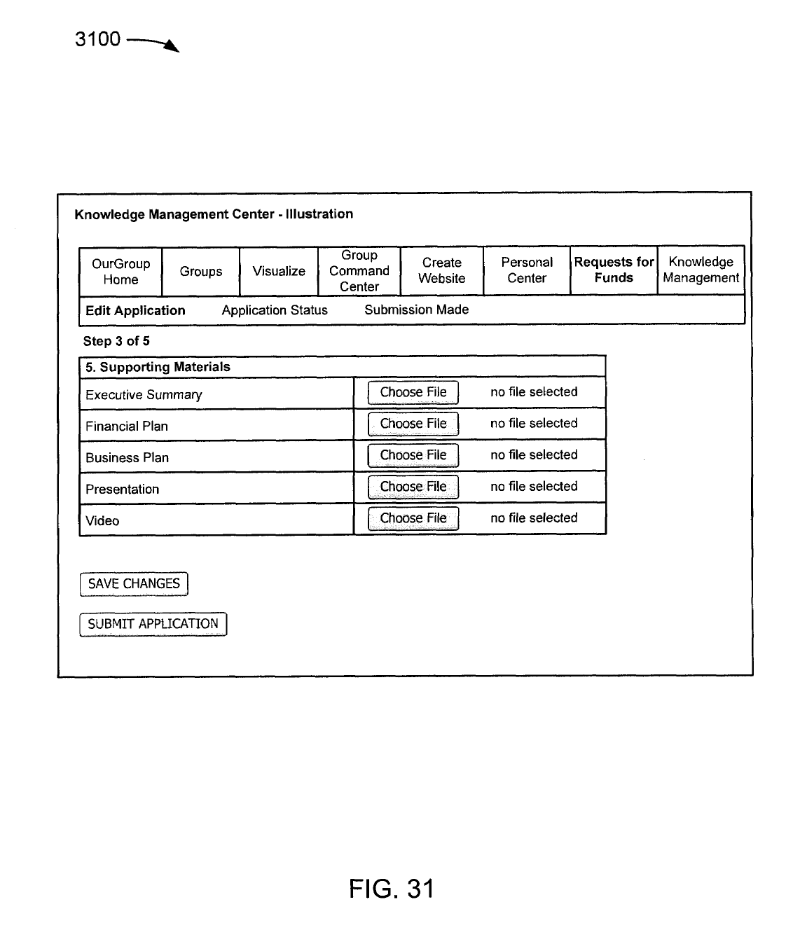

FIG. 28 depicts a screenshot 2800 of a flow diagram depicting a fundraising and fund allocation chain. In the example of FIG. 28, the flow begins with individual donors who provide funds directly to users of funds or alternatively to foundations and charities. Such foundations and charities can provide the funding to users of funds directly or indirectly through allocation review committees. FIG. 29 depicts a screenshot 2900 of an example of an interface that can be used to request funds, as discussed above. In the example of FIG. 29, the interface can collect group information such as contact, management, and profile information. FIG. 30 depicts a screenshot 3000 of an example of an interface that can be used to define reasons for fundraising. Such reasons could include problems to be solved, funds desired, quantitative and qualitative measures for success, and qualifications for requesting funding. FIG. 31 depicts a screenshot 3100 of an example of an interface that can be used to provide supporting materials to a request for fundraising. Such supporting materials can include summaries, plans, presentations, videos and other known or convenient request support materials.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

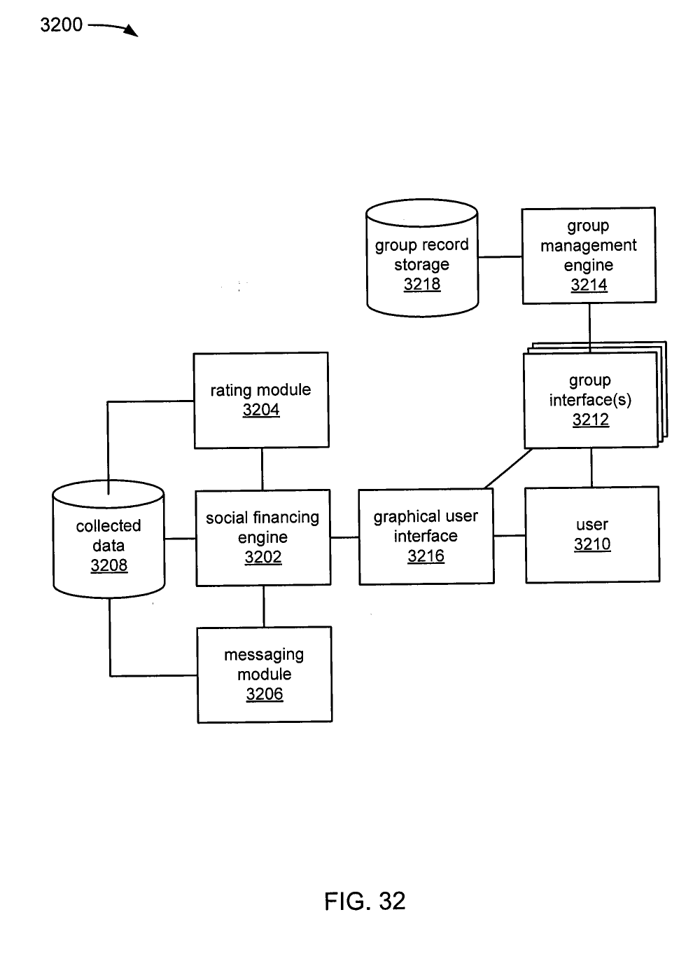

FIG. 32 depicts an example of a system for storing and retrieving information. FIG. 32 includes social investment engine 3202, rating module 3204, messaging module 3206, collected data repository 3208, user 3210, group interface(s) 3212, group management engine 3214, graphical user interface 3216, and group record storage 3218.

In the example of FIG. 32, the social investment engine 3202 can manage data and user requests. In a non-limiting example, the social investment engine 3202 can store data received at a graphical user interface into a collected data repository. Alternatively, the social investment engine 3202 can receive direct contacts or other data to a rating module for application of a rating. Additionally, the social investment engine 3202 can process messages to and from the user. Further the social investment engine 3202 can perform other known or convenient data management tasks.

As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. As used herein an engine can include software implemented on hardware.

In the example of FIG. 32, the rating module 3204, can receive data and user input defining a rating and store the rating in association with the data within a collected data repository. For example, the rating module 3204 can receive a contact and a rating of 5 stars for the contact and can store the contact in the collected data repository in association with the rating. Alternatively, the rating module 3204 could receive a link to a webpage along with user input defining a rating and store the rating in association with the link. Further, the rating module 3204 can receive any known or convenient data and can store the data in association with the rating.

In the example of FIG. 32, the messaging module 3206, can store and retrieve messages, such as email. Where the messages are emails, the messages can be communicated through a mail server, for example, an SMTP (Simple Mail Transfer Protocol) server, an IMAP (Internet Message Access Protocol) server, or any other known or convenient server. The messaging module 3206 can be a mail client operable to transfer mail with mail servers. Alternatively, the messaging module 3206 can be an ad hoc communications manager for, e.g. communications over an intranet. Further, messaging module 3206 can be any known or convenient system for handling messages.

In the example of FIG. 32, the collected data repository 3208 can store data on behalf of a user. The collected data repository 3208, or a portion thereof, can be associated with the user so that when requested, data is stored into the relevant locations within the collected data repository 3208. For example, such data can include links to web pages, images, messages, contacts, text, documents, and any known or convenient data.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 32, the user 3210 can be a member as discussed in reference to FIG. 1, another individual, or any known or convenient user.

In the example of FIG. 32, the group interface(s) 3212, the group knowledge management engine 3214, and group record storage 3218 can be as described in reference to FIG. 2.

In the example of FIG. 32, the graphical user interface 3216 can include a closed mode static image and an expanded mode graphical user interface.

The closed mode static image can be a simple graphic. For example, the closed mode static image can be a clickable button. Alternatively, the closed mode static image could be a tab on a menu bar. Further, the closed mode static image can be any known or convenient device for triggering the expanded mode graphical user interface.

The expanded mode graphical user interface can display data to a user and offer tools to collect data from user pages. For example, the expanded mode graphical user interface could be a tabbed interface displaying bookmarked members, my contacts, my documents, and my messages. Therein, each of the tabs could be associated with pages including data related to the tabs. Alternatively, the expanded mode graphical user interface could include a layout of data and hyperlinks operable to display information to a user. Further, the expanded mode graphical user interface could be any known or convenient system for displaying data.

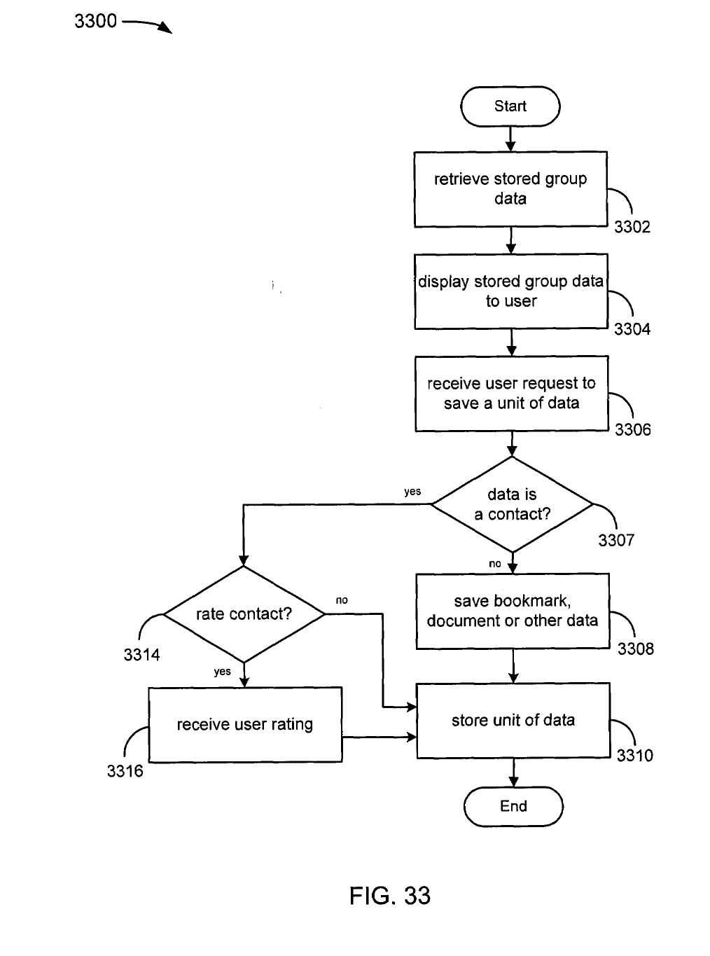

FIG. 33 depicts a flowchart of an example of a method for acquiring data. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 33, the flowchart starts at module 3302 with retrieving stored group data. The stored group data could be retrieved from a repository such as group records storage. Alternatively, the stored group data could be retrieved from a webpage. Further the stored group data could be retrieved from any known or convenient source.

In the example of FIG. 33, the flowchart continues to module 3304 with displaying stored group data to a user. The information can be retrieved from a repository associated with groups the user is viewing. This information can be displayed through a web browser to the user. An expanded mode graphical user interface can be used, or alternatively any known or convenient device for displaying data can be used.

In the example of FIG. 33, the flowchart continues to module 3306 with receiving a user request to save a unit of data. The request can be initiated through an expanded mode graphical user interface. For example, the user could select the unit of data for storage by clicking, selecting, or otherwise interacting with the expanded mode graphical user interface.

Where a graphical user interface is in a closed mode, such as by displaying only a closed mode static image, the expanded mode graphical user interface can be displayed by interacting with the closed mode static image. As used herein, an “interaction” can be a mouse click, user selection, keystroke, or other known or convenient input for the closed mode static image.

In the example of FIG. 33, the flowchart continues to decision module 3307 with deciding whether the unit of data is a contact. The decision can be yes if the data includes a name, email address, phone number, v-card, or other known or convenient contact data container. The decision can be no for all other data.

In the example of FIG. 33, from module 3307, if the decision is yes, the flowchart continues to decision module 3314 with deciding whether to rate a contact. The decision can be yes if a user inputs a rating for the contact. For example, a user could select a 1-5 star rating for the contact. Alternatively, a user could enter a likes or dislikes rating. Further any known or convenient rating could be used.

The decision at decision module 3314 can be no where the user specifies no ranking for the contact. The user could leave a contact rating blank signifying a lack of interest to rate the contact. Alternatively, the user could specify that no ranking will be given. Further, any known or convenient manner of indicating a lack of desire to rank can be used.

In the example of FIG. 33, from module 3314, if the decision is yes, the flowchart continues to module 3316 with receiving a user rating. The user can click, type, or otherwise enter the rating. For example, where stars are used, the user could click a number of stars. Alternatively, where a text rating is used, the user could type in the rating. Further, any known or convenient manner of entering the rating can be used.

In the example of FIG. 33, from module 3307, if the decision is no, the flow chart continues to module 3308 with saving the bookmark, document, or other data. For example, the bookmark, document, or other data can be saved to a repository, such as a collected data repository. Alternatively, the data can be saved to a folder. Further, any known or convenient manner of saving data can be used.

In the example of FIG. 33, from module 3316, or from module 3314 if the decision is no, or from module 3307, if the decision is no, the flowchart continues to module 3310 with storing the unit of data. Having stored the unit of data, the flowchart terminates.

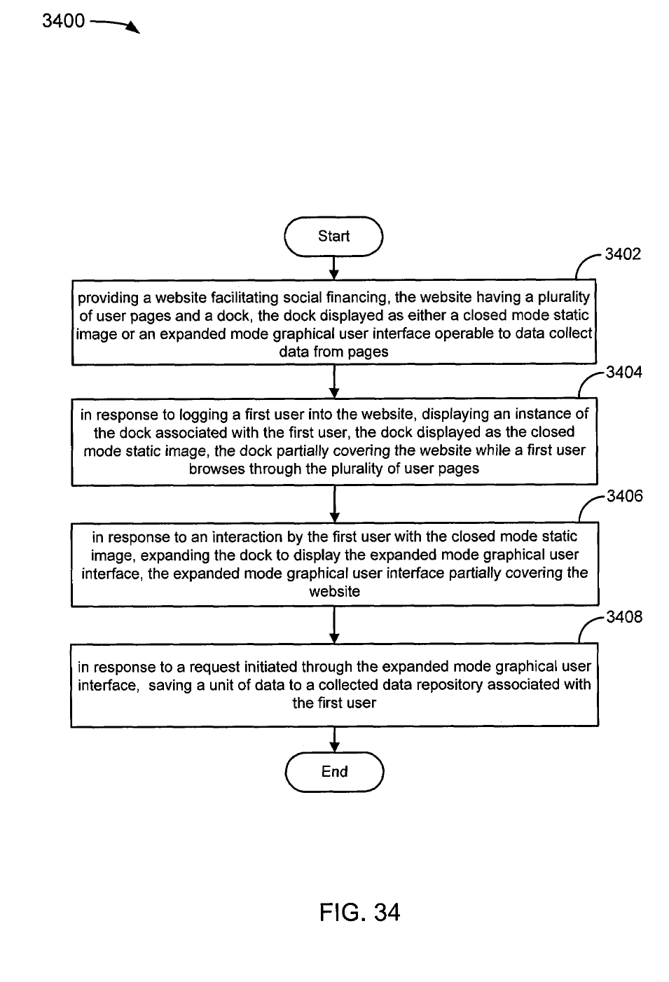

FIG. 34 depicts a flowchart of an example of a method for saving a unit of data from a website facilitating social financing and/or investment. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

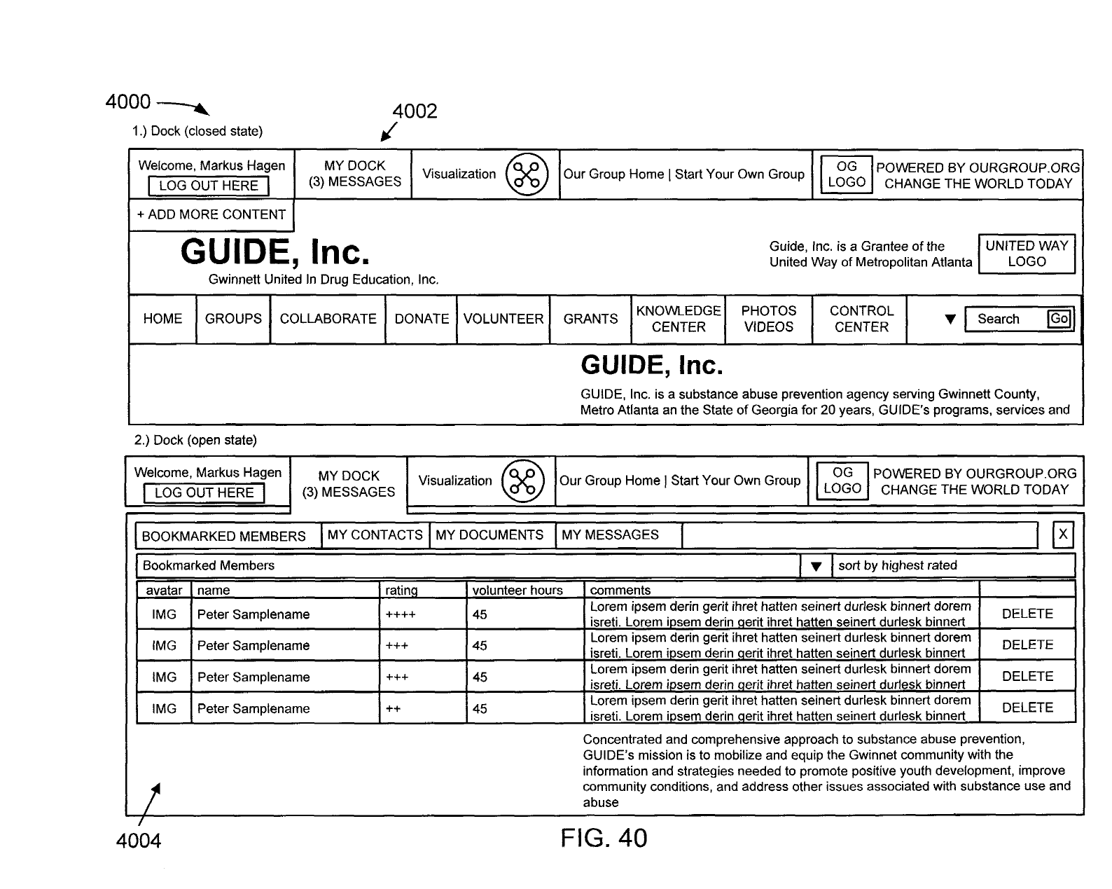

In the example of FIG. 34, the flowchart starts at module 3402 with providing a website facilitating social financing and/or investment, the website having a plurality of user pages and a dock, the dock displayed as either a closed mode static image or an expanded mode graphical user interface operable to data collect data from pages. For example, a screenshot of an example of a dock is provided in FIG. 40.

In the example of FIG. 34, the flowchart continues to module 3404 with, in response to logging a first user into the website, displaying an instance of the dock associated with the first user, the dock displayed as the closed mode static image, the dock partially covering the website while a first user browses through the plurality of user pages. The dock can have the closed mode static image set as an initial display that expands upon interaction with the closed mode static image.

In the example of FIG. 34, the flowchart continues to module 3406 with, in response to an interaction by the first user with the closed mode static image, expanding the dock to display the expanded mode graphical user interface, the expanded mode graphical user interface partially covering the website. Portions of the expanded mode graphical user interface can be translucent so as to allow the website to be seen through the expanded mode graphical user interface. With the expanded mode graphical user interface open, the user can select data for storage into the collected data repository associated with the user.

In the example of FIG. 34, the flowchart continues to module 3408 with, in response to a request initiated through the expanded mode graphical user interface, saving a unit of data to a collected data repository associated with the first user. The user can select data for storage into the collected data repository using the expanded mode graphical user interface. For example, the user can highlight data on the page and select save from the expanded mode graphical user interface. Alternatively, links can be used to select data for storage into the collected data repository. Further any known or convenient manner of saving data can be used. Having saved a unit of data to the repository, the flowchart terminates.

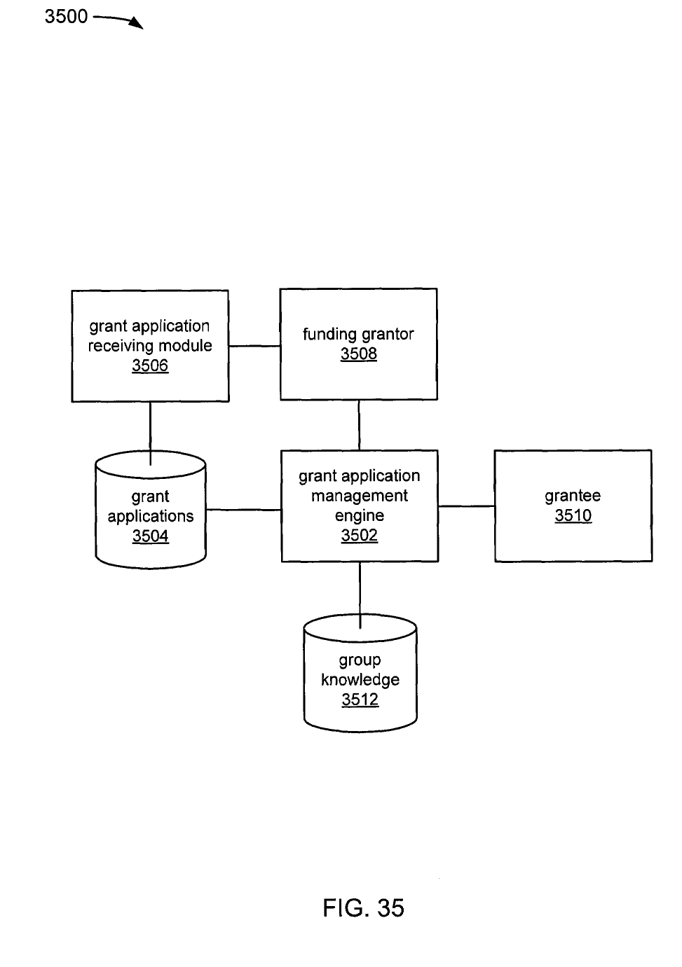

FIG. 35 depicts an example of a grant application management system. FIG. 35 includes grant application management module 3502, grant applications repository 3504, grant application receiving module 3506, funding grantor 3508, grantee 3510, and group knowledge repository 3512.

In the example of FIG. 35, grant application management engine 3502 can control file storage and retrieval as well as manage information to be added to grant applications. For example, the grant application management engine 3502 can retrieve information and add it to a grant application. Further the grant application management engine 3502 can store new grant applications in a grant applications repository. Additionally, the grant application management engine 3502 can otherwise manage grant applications and information in any known or convenient manner.

In the example of FIG. 35, grant applications repository 3504 can store grant applications, grant application templates, partially filled grant applications, and any known or convenient data related to a grant application.

As used herein, a “grant application template” is a document provided by a grantor including various questions for a potential grantee to answer in applying for the grant.

In the example of FIG. 35, the grant application receiving module 3506 receives applications from funding grantors and stores the grant applications in a grant applications repository.

In the example of FIG. 35, funding grantor 3508, can be an individual, foundation, group of individuals, or other entity providing funds offered as a grant or grants to individuals furthering the interest of the funding grantor 3508.

In the example of FIG. 35, grantee 3510 can be an individual, group, organization, or other known or convenient entity seeking a grant of funding.

In the example of FIG. 35, group knowledge repository 3512 can be a group record storage as defined in reference to FIG. 2.

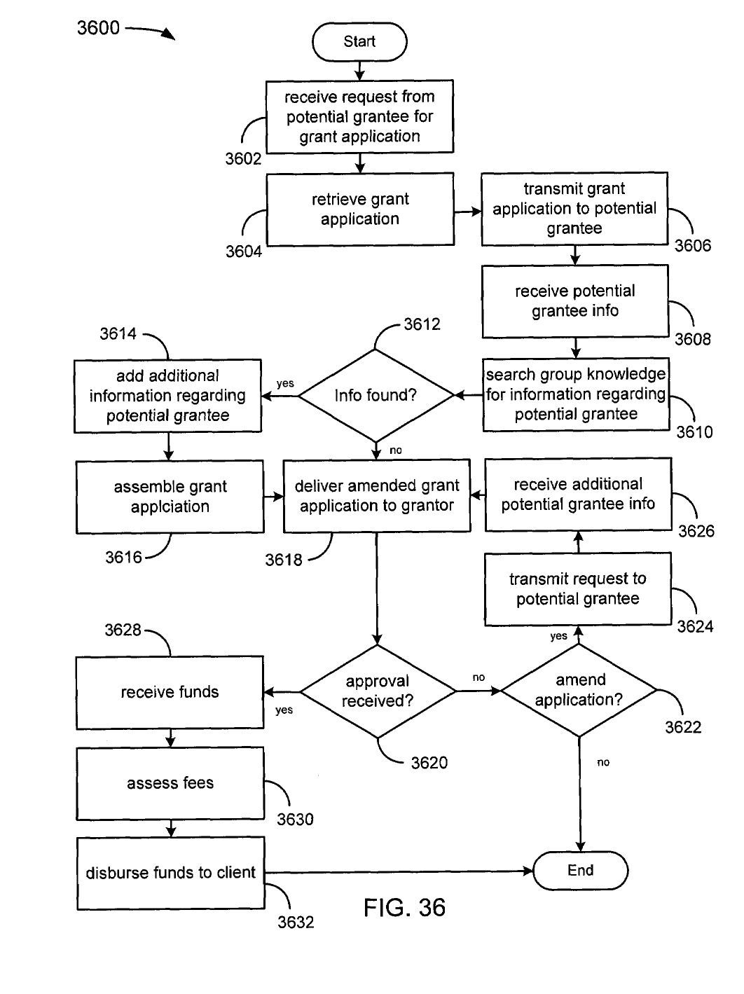

FIG. 36 depicts a flowchart of an example of a method for managing grant applications. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 36, the flowchart begins at module 3602 with receiving a request from potential grantee for a grant application. The potential grantee can initiate the request via, for example, a click action directed to a link on a website. The website can display the grant applications. Alternatively, the user can communicate the request via a database request. Further, any known or convenient manner of communicating the request can be used.

In the example of FIG. 36, the flowchart continues to module 3604 with retrieving a grant application. The grant application can be retrieved from a grant application repository. For example, the retrieval can be a copy operation from storage. Alternatively, the retrieval can be from a database. Further, any known or convenient method could be used to.

In the example of FIG. 36, the flowchart continues to module 3606 with transmitting the grant application to the potential grantee. The application could be transmitted by the hypertext transfer protocol (HTTP). Alternatively, the document could be emailed to the potential grantee. Further, any known or convenient method of transmitting the document could be used.

In the example of FIG. 36, the flowchart continues to module 3608 with receiving potential grantee information. The information can be formatted to the grant application, can be included in the grant application, or can be otherwise prepared for the grant application.

In the example of FIG. 36, the flowchart continues to module 3610 with searching group knowledge for information regarding the potential grantee. The potential grantee may have submitted grant applications before, and may be associated with a group for which the potential grantee is preparing the grant application. All of the prior actions of the individual and the group can be recorded and used in future grant applications. This information can be helpful to a grantor in deciding whether to fund the grant application as requested by the potential grantee.

In the example of FIG. 36, the flowchart continues to decision module 3612 with determining whether information on the potential grantee is found. The determination can be made by searching a group knowledge repository. For example, the knowledge repository can be searched for information about the individual. Alternatively, groups related to the individual can be searched. Further any known or convenient search can be performed to determine whether the potential grantee can be found in the records.

In the example of FIG. 36, from decision module 3612, if the decision is yes, the flowchart continues to module 3614 with adding additional information regarding the potential grantee. If information was found at module 3612, then the information can be incorporated into the grant application.

The information can include information other than the information that the potential grantee included in the application. For example, the information can include the successes or failures the potential grantee has had with previous grants. Alternatively, the information could include the number of grant applications that the potential grantee has previously filed. Further, any known or convenient information regarding the potential grantee can be used.

In the example of FIG. 36, from module 3614, the flowchart continues to module 3616 with assembling the grant application. The grant application can be assembled to include the information that the potential grantee provided, the information that is retrieved from the group knowledge repository and any other known or convenient information.

In the example of FIG. 36, from module 3616, or from decision module 3612, if the decision is no, the flowchart continues to module 3618 with delivering the grant application to grantor or administrator of the grant. The application can be sent by, for example, HTTP, email, File Transfer Protocol (FTP) or any known or convenient protocol.

In the example of FIG. 36, from module 3618, the flowchart continues to decision module 3620 with deciding whether approval is received. After reviewing the grant application, the grantor can transmit an approval or denial. If the grantor transmits a denial the decision at module 3620 will be no, if the grantor transmits an approval, the decision at module 3620 will be a yes.

In the example of FIG. 36, from module 3620, if the decision is no, the flowchart continues to decision module 3622 with deciding whether to amend the application. A potential grantee can decide whether to amend the application if there is additional information that could change the outcome of the grantor's decision, and if the grantor will consider reviewing the amended application. Where the grantor will review the amended application and there is additional information, the decision at module 3622 can be yes. Alternatively, the decision is no.

In the example of FIG. 36, from module 3622, if the decision is yes, the flowchart continues to module 3624 with transmitting the request to the potential grantee. Having decided to amend the application, the potential grantee is asked to provide information that will potentially change the outcome of the grant application. For example, the potential grantee could provide examples of how funding will be spent. Alternatively, the potential grantee could change the composition of a board that would be expending the funds. Further the application can be amended in any known or convenient manner.

In the example of FIG. 36, from module 3624, the flowchart continues to module 3626 with receiving additional potential grantee info. The additional information can be incorporated into the amended grant application.

In the example of FIG. 36, from module 3626, the flowchart continues to module 3618 with delivering the amended grant application to the grantor. The amended grant application can be transmitted as discussed above by any known or convenient protocol.

In the example of FIG. 36, from module 3618, the flowchart continues to module 3620 with determining whether approval has been received for the grant application. The decision can be yes if the amended application is approved and no if the amended application is denied.

In the example of FIG. 36, from decision module 3620, if the decision is yes, the flowchart continues to module 3628 with receive funds. The funds can be received into an associated bank account. For example, the automated clearing house (ACH), wire transfer, or other known or convenient method of funds transfer can be used.

In the example of FIG. 36, from module 3628, the flowchart proceeds to module 3630 with assessing fees. The grant application management process can be valued at a reasonable fee for the services rendered. This fee can be deducted from the funds received.

In the example of FIG. 36, from module 3630, the flowchart continues to module 3632 with delivering funds to the grantee. For example, the funds can be deposited into an account specified by the grantee and alternatively any known or convenient manner of disbursing the funds can be used.

In the example of FIG. 36, from module 3622, or from decision module 3632, if the decision is no, the flowchart terminates. Where the decision at module 3622 is no the potential grantee has decided not to amend the application, and has therefore decided to terminate the application process. From module 3632, the funds have been disbursed to the grantee; therefore the grant application process is complete.

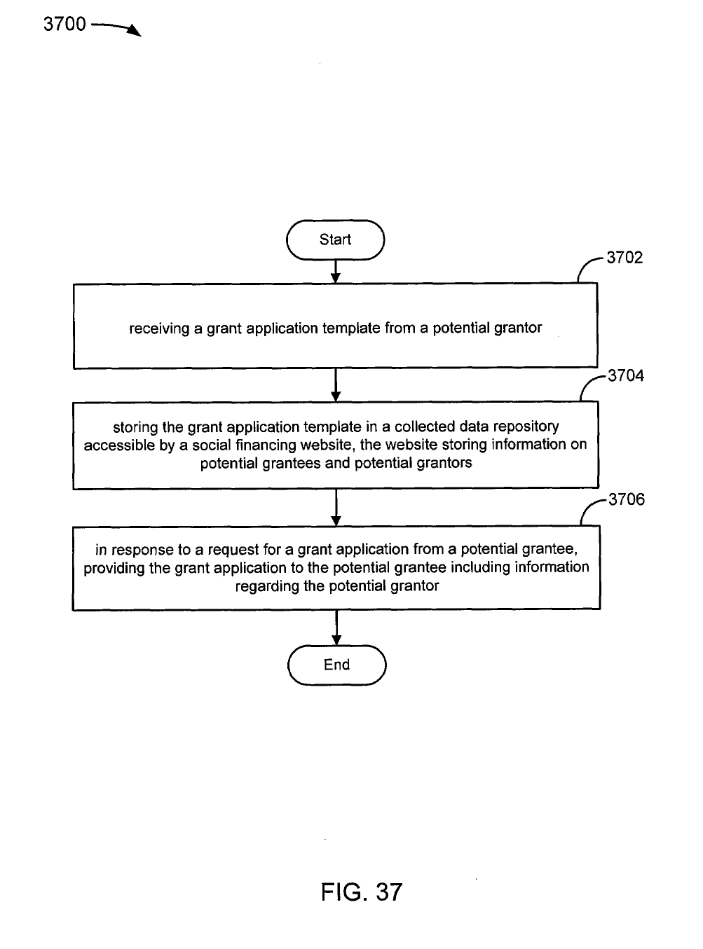

FIG. 37 depicts a flowchart of an example of a method for acquiring a grant application template. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 37, the flowchart starts at module 3702 with receiving a grant application template from a potential grantor. The grant application template can be acquired in a process such as one discussed in reference to FIG. 36; such as by electronic transmission of the application template.

In the example of FIG. 37, the flowchart continues to module 3704 with storing the grant application template in a collected data repository accessible by a social investment website, the website storing information on potential grantees and potential grantors. The social investment website can be a website facilitating interaction between individuals and groups for the purpose of investing time and/or funds in worthy causes. The grant application template can be stored in any known or convenient database, such as is discussed in reference to FIG. 35 and FIG. 36.

In the example of FIG. 37, the flowchart continues to module 3706 with, in response to a request for a grant application from a potential grantee, providing the grant application to the potential grantee including information regarding the potential grantor. The potential grantee can transmit the request to the social investment website, and in response the website can send the application. Having provided the grant application to the potential grantee, the flowchart terminates.

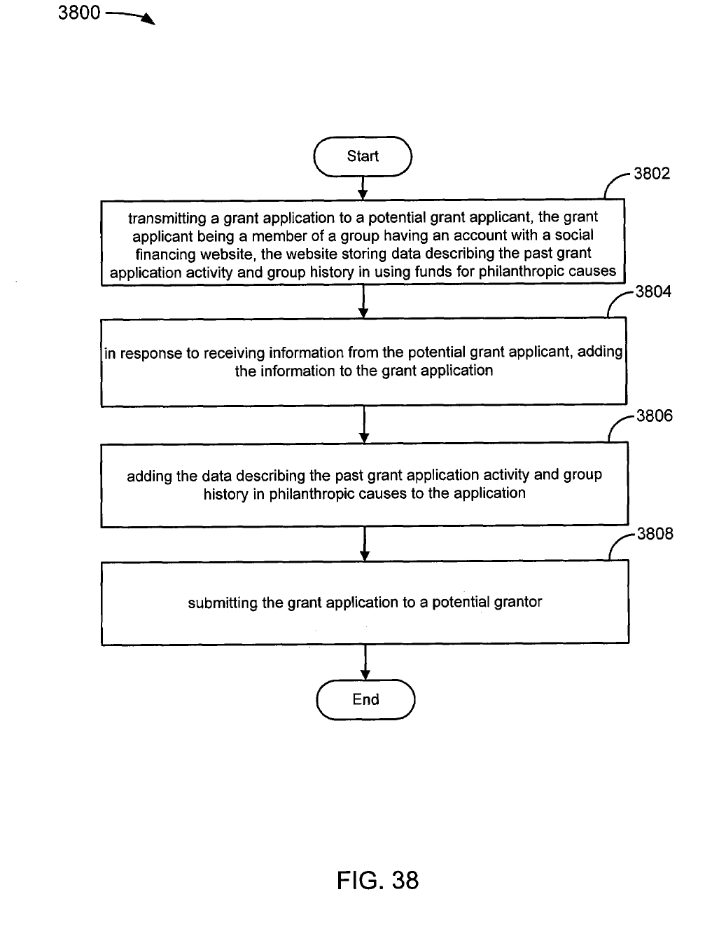

FIG. 38 depicts a flowchart of an example of a method for preparing a grant application. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 38, the flowchart starts at module 3802 with transmitting a grant application to a potential grant applicant, the grant applicant being a member of a group having an account with a social investment website, the website storing data describing the past grant application activity and group history in using funds for philanthropic causes. The grant application can be transmitted using any known or convenient protocol. The transmission of the grant application is discussed further in reference to FIG. 36.

In the example of FIG. 38, the flowchart starts at module 3804 with in response to receiving information from the potential grant applicant, adding the information to the grant application. The information can be combined with a grant application template to produce a completed grant application.

In the example of FIG. 38, the flowchart starts at module 3806 with adding the data describing the past grant application activity and group history in philanthropic causes to the application. The information can be retrieved from a group knowledge repository and included into the application and the completed application can include information that was not included by the potential grantee.

In the example of FIG. 38, the flowchart starts at module 3808 with submitting the grant application to a potential grantor. The application can be transmitted to the grantor using any known or convenient method, such as one discussed in regard to FIG. 36. Having submitted the grant application to a potential grantor, the flowchart terminates.

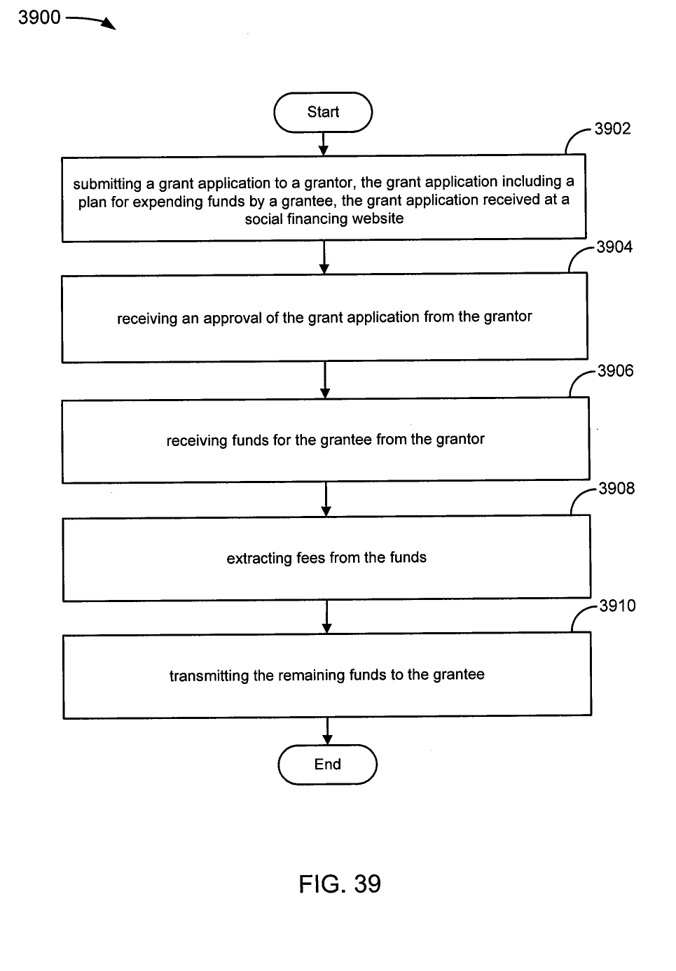

FIG. 39 depicts a flowchart of an example of a method for managing submission of an approved grant application. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 39, the flowchart starts at module 3902 with submitting a grant application to a grantor, the grant application including a plan for expending funds by a grantee, the grant application received at a social investment website. The grant application is presumed to be complete for review, and at module 3902 the grant application can be transmitted to the grantor for such review.

In the example of FIG. 39, the flowchart starts at module 3904 with receiving an approval of the grant application from the grantor. Where a grantor has positively evaluated the grantee's request for funds, the grantor can transmit an approval of the application.

In the example of FIG. 39, the flowchart starts at module 3906 with receiving funds for the grantee from the grantor. The approval of the grant can be followed by the transmission of funds for the grantee to use as described in the application. The transmission of funds is discussed further in regard to FIG. 36.

In the example of FIG. 39, the flowchart starts at module 3908 with extracting fees from the funds. The fees can be extracted in regard to reasonable value for the services provided. The extraction of fees is also discussed further in regard to FIG. 36.

In the example of FIG. 39, the flowchart starts at module 3910 with transmitting the remaining funds to the grantee. The remaining funds can be deposited in an account for the grantee, or otherwise made available to the grantee for use as described in the grant application. Having transmitted the remaining funds to the grantee, the flowchart terminates.

FIG. 40 depicts an example of a personalized dock used in conjunction with a particular website. The dock, whether in the closed state or open state, is anchored to a fixed position on the user's display, such as at the top or side of the screen. In one embodiment, the dock can be moved from one location to another location on the display by the user. When a user logs into the website, the personalized dock for that user is displayed; and the user can store information of interest in the dock and retrieve previously stored information, thus using the dock as an easily accessible storage facility for sorting information pulled from the website. For example, a user can visualize the members of a particular group using the website and select a specific member of the group to be bookmarked in the user's personalized dock under a ‘members’ section of the dock. In one embodiment, an event being sponsored by a group at a specific date and time can be stored in the user's calendar in the dock. In one embodiment, a document, for example on the importance of fund-raising to eradicate a disease in third-world countries, such as malaria, can be selected by the user to be bookmarked in his personalized dock to allow easy reference to the document in the future. These examples of uses for the dock allow a user to browse through links on the website and store information of interest. The personalized dock can even function as a mailbox for the user to receive email, SMS, or text-based tweet messages sent through the social messaging utility Twitter. Categories of items from the website that can be stored in the dock include, but are not limited to, group members, contacts, calendar events, documents, and messages.

FIG. 40 shows my dock in a closed state 4002 and in an expanded state 4004. As depicted in FIG. 40, my dock (closed) 4002 is a static image viewed above, or in any other position relative to a window for a website. Because the dock is anchored to the website in a fixed location, the user can choose to access information stored in the dock at any time by clicking on the dock. When clicked, my dock (closed) 4002 expands to become my dock (expanded) 4004. In the expanded state, the dock provides tabs or some other convenient layout for accessing each of several categories of information that the dock can store, for example contacts or messages. Users can then access bookmarked members, my contacts, my documents and my messages.

As described above, the personalized dock can be integrated within a particular website. In one embodiment, the dock can be a web browser application such that the dock can be used as a storage facility for any website accessed by the user through a web browser. To run a user's personalized dock browser application, the user must first login. All information previously stored to the dock by the user will then become accessible through the dock. Thus, while a user is accessing websites using a browser application, the dock can be placed in the closed state. When the user wishes to store a unit of data from one of the websites that is being browsed by the user, the user can open the dock to the expanded state and submit a request for storing the unit of data from the website. Also, the user can request retrieval of a particular unit of data that was previously stored. The retrieved data can be displayed in the expanded state of the dock or in another window of the web browser.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems appears in the description above. In addition, the present example is not described with reference to any particular programming language, and various examples may thus be implemented using a variety of programming languages.

What is claimed is:

1. A method of facilitating a grant application process, the method comprising:
receiving a grant application template from a potential grantor;
storing the grant application template in a collected data repository accessible by a social investment website, the website storing information on potential grantees and potential grantors;
in response to a request for a grant application from a potential grantee, providing the grant application to the potential grantee including information regarding the potential grantor.

2. The method of claim 1, wherein the information regarding the potential grantor includes a history of previous grants.

3. The method of claim 2, wherein the history of previous grants includes funding amounts.

4. The method of claim 2, wherein the history of previous grants includes groups receiving funding.

5. A method of facilitating a grant application process, the method comprising:
transmitting a grant application to a potential grant applicant, the grant applicant being a member of a group having an account with a social investment website, the website storing data describing the past grant application activity and group history in using funds for philanthropic causes;
in response to receiving information from the potential grant applicant, adding the information to the grant application;
adding the data describing the past grant application activity and group history in philanthropic causes to the application; and
submitting the grant application to a potential grantor.

6. The method of claim 5, further comprising preparing potential grant applicant data, the potential grant applicant data including the past grants that the grant applicant has received.

7. The method of claim 5, further comprising preparing potential grant applicant data, the potential grant applicant data including the past successes of the potential grant applicant.

8. A method of facilitating a grant approval and funding process, the method comprising:
submitting a grant application to a grantor, the grant application including a plan for expending funds by a grantee, the grant application received at a social investment website;
receiving an approval of the grant application from the grantor;
receiving funds for the grantee from the grantor;
extracting fees from the funds; and
transmitting the remaining funds to the grantee.

9. The method of claim 8, further comprising receiving instructions on the expenditure of the funds from the grantor; and providing the instructions to the grantee.

10. The method of claim 8, wherein the funds are stored on behalf of the grantee in an account for the grantee.

11. A system for facilitating a grant application process, the system comprising:
a grant application management engine;
a group knowledge repository;
a grant applications repository;
wherein, in operation,
the grant application management engine receives a request for a grant application from a potential grantee, the grant application being stored in the grant applications repository;
in response to the request, the grant application management engine retrieves the grant application from the grant application and transmits the application to the potential grantee;
the grant application management engine receives a request to submit the grant application, the request including information used to fill out the grant application;
the grant application management engine retrieves past history information describing the potential grantee the group knowledge repository and adds the past history information to the grant application; and
the grant application management engine submits the grant application to a potential grantor.

12. The system of claim 11, further comprising a grant application receiving module,
wherein, in operation,
the grant application receiving module receives a grant application template from a potential grantor and stores the grant application template in a grant application repository.

13. A method for storing and retrieving data comprising:
providing a website facilitating social investment, the website having a plurality of user pages and a dock, the dock displayed as either a closed mode static image or an expanded mode graphical user interface operable to collect data from pages;
in response to logging a first user into the website, displaying an instance of the dock associated with the first user, the dock displayed as the closed mode static image, the dock partially covering the website while a first user browses through the plurality of user pages;
in response to an interaction by the first user with the closed mode static image, expanding the dock to display the expanded mode graphical user interface, the expanded mode graphical user interface partially covering the website; and
in response to a request initiated through the expanded mode graphical user interface, saving a unit of data to a collected data repository associated with the first user.

14. The method of claim 13, further comprising maintaining display of the expanded mode graphical user interface over a second website when navigating away from the website facilitating social investment.

15. The method of claim 14, wherein the second website includes a second unit of data; further comprising saving the second unit of data to the collected data repository associated with the first user.

16. The method of claim 13, wherein the unit of data is a contact.

17. The method of claim 16, further comprising rating the contact and storing the rating in association with the contact in the collected data repository associated with the first user.

18. The method of claim 13, further comprising receiving a message for the first user, and storing the message in the collected data repository associated with the first user.

19. The method of claim 18, wherein the message is received from a second user of the website, the message being identified as originating from a member of a group with which the second user is associated.

20. The method of claim 19, further comprising identifying previous messages the first user has received from the second user.

21. The method of claim 13, further comprising receiving entry of a message from the first user in the expanded mode graphical user interface and transmitting the message to a recipient.

22. The method of claim 13, further comprising retrieving the unit of data from the collected data repository and displaying the unit of data in the expanded mode graphical user interface.

23. The method of claim 13, further comprising, in response to receiving an instruction in the expanded mode graphical user interface to close the expanded mode graphical user interface, reducing the expanded mode graphical user interface to display only the closed mode static image.

24. A dock system comprising:
a social investment engine configured to perform data management tasks;
a closed mode static image configured to expand into an expanded mode graphical user interface upon receiving a user input;
the expanded mode graphical user interface configured provide tools for collecting data from a website and display the data; and
a collected data repository associated with a first user configured to store units of data from the website specified by the first user;
wherein, in operation,
in response to logging the first user into the website, the social investment engine displays the closed mode static image while the first user browses through a plurality of user pages;
in response to the user input from the first user with the closed mode static image, the social investment engine expands the closed mode static image to partially cover the website with the expanded mode graphical user interface; and
in response to receiving a request to save a unit of data, the request initiated through the expanded mode graphical user interface, the social investment engine saves the unit of data to the collected data repository associated with the first user.

25. The system of claim 24, further comprising a rating module,
wherein, in operation,
the expanded mode graphical user interface receives a rating associated with the unit of data; and
the social investment engine stores the rating in association with the unit of data in the collected data repository associated with the first user.

26. The system of claim 25, wherein the unit of data is a contact.

27. The system of claim 24, further comprising a messaging module,
wherein, in operation,
the messaging module receives a message for the first user,
stores the message in the collected data repository associated with the first user; and
displays the message to the first user.

28. The system of claim 27, wherein the message is received from a second user of the website, the message being identified as originating from the second user including an association of the second user with a group with which the second user is associated.

29. The system of claim 27, wherein the messaging module identifies previous messages received from a second user transmitting the message.

30. The system of claim 27, wherein the messaging module retransmits a message generated in the expanded mode graphical user interface.

31. The system of claim 24, wherein while the first user browses through a second website the expanded mode graphical user interface remains displayed over the second website.

32. The system of claim 31, wherein the second website includes a second unit of data; further comprising saving the second unit of data to the collected data repository associated with the first user.

33. The system of claim 24, wherein the social investment engine retrieves the unit of data from the collected data repository and displays the unit of data in the expanded mode graphical user interface.

34. The system of claim 24, wherein, in response to a close instruction received at the expanded mode graphical user interface, the expanded mode graphical user interface shrinks to display only the closed mode static image.

35. A computer-implemented method of storing and retrieving information from websites accessed through a web browser, comprising:
in response to a user logging into a dock application, displaying an instance of a closed mode static image of a dock, wherein the dock is located in a portion of a display screen while the user accesses one or more websites through the web browser;
in response to an interaction by the user with the closed mode static image, expanding the dock to display an expanded mode graphical user interface, wherein the expanded mode graphical user interface partially covers the web browser;
in response to a save request initiated through the expanded mode graphical user interface, saving a first unit of data from the one or more websites to a collected data repository associated with the user;
in response to a retrieve request initiated through the expanded mode graphical user interface, retrieving a second unit of data from the collected data repository and displaying the second unit of data.

36. The computer-implemented method of claim 35 wherein the second unit of data is displayed in the expanded mode graphical user interface.

37. The computer-implemented method of claim 35 wherein the second unit of data is displayed in a window in the web browser.

38. A dock system, comprising:
a social investment engine configured to perform data management tasks;
a closed mode static image configured to expand into an expanded mode graphical user interface upon receiving a user input;
the expanded mode graphical user interface configured to provide tools for collecting data from a plurality of webpages accessed through a web browser and display the data; and
a collected data repository associated with a first user configured to store units of data specified by the first user from the plurality of webpages;
wherein, in operation,
in response to logging the first user into the dock system, the social investment engine displays the closed mode static image while the first user accesses the web browser;
in response to an interaction from the first user with the closed mode static image, the social investment engine expands the closed mode static image to partially cover the web browser with the expanded mode graphical user interface;
in response to receiving a request to save a first unit of data from a webpage accessed through the web browser, the request initiated through the expanded mode graphical user interface, the social investment engine saves the first unit of data to the collected data repository associated with the first user; and
in response to a close instruction received at the expanded mode graphical user interface, the expanded mode graphical user interface shrinks to display only the closed mode static image.

39. The dock system of claim 38, further wherein, in response to receiving a request to retrieve a second unit of data from the collected data repository, the social investment engine retrieves the second unit of data from the collected data repository and displays the second unit of data in the expanded mode graphical user interface or in a window in the web browser.
